(19) United States
(12) Patent Application Publication
(10) Pub. No.: US 2026/0034810 A1
(43) Pub. Date: Feb. 5, 2026

(54) STACKING DEVICE

(71) Applicant: CANON KABUSHIKI KAISHA, Tokyo (JP)

(72) Inventors: MASAKAZU TSUKUDA, Kanagawa (JP); TOSHIKI HAMANISHI, Kanagawa (JP); KATSUAKI SUKEGAWA, Kanagawa (JP); HIROTAKA ENDO, Kanagawa (JP); MASAAKI MATSUURA, Kanagawa (JP); KEN TAKENAGA, Kanagawa (JP); TOMOYA HARA, Kanagawa (JP)

(21) Appl. No.: 19/284,928

(22) Filed: Jul. 30, 2025

(30) Foreign Application Priority Data
Jul. 31, 2024 (JP) 2024-124844

(51) Int. Cl. B41J 13/10; F16H 35/12; F16H 37/12

(52) U.S. Cl. CPC B41J 13/106; F16H 35/12; F16H 37/124

(57) ABSTRACT

A technology that enables downsizing of an apparatus is to be provided. The technology includes: a stacking unit configured to expand or contract in a conveyance direction of a print medium to be conveyed and discharged, and configured to be movable in a width direction of the print medium, which intersects with the conveyance direction, and to be capable of stacking the print medium to be discharged; and a transmission unit configured to transmit a driving force from a drive source to the stacking unit, wherein the transmission unit transmits the driving force such that a timing at which the stacking unit expands or contracts in the conveyance direction differs from a timing at which the stacking unit moves in the width direction.

### BACKGROUND

### Field of the Technology

The present disclosure relates to a stacking device for stacking print media.

### Description of the Related Art

There is a known technology in which, in a printing apparatus that discharges print media after printing and stacks them on a stacking part, the stacking part is moved to sort the print media into a certain number of sheets. The Japanese Patent Laid-Open No. 2015-160715 discloses a technology in which, while sorting print media, the stacking part is moved diagonally with respect to the conveyance direction, thereby ensuring an area where a bundle of print media to be sorted will not overlap with the already sorted bundle of print media.

However, in the technology disclosed in Japanese Patent Laid-Open No. 2015-160715, the stacking part is formed in a size capable of stacking print media of various sizes, and is installed such that a large part of the stacking part protrudes from the printing apparatus. Therefore, the printing apparatus has become large in size, and a large space has been required for installation of the printing apparatus.

### SUMMARY

The present disclosure has been made in view of the above-mentioned issue, and provides a technology that enables downsizing of an apparatus.

A stacking device according to some embodiments includes a stacking unit configured to expand or contract in a conveyance direction of a print medium to be conveyed and discharged, and configured to be movable in a width direction of the print medium, which intersects with the conveyance direction, and to be capable of stacking the print medium to be discharged; and a transmission unit configured to transmit a driving force from a drive source to the stacking unit, wherein the transmission unit transmits the driving force such that a timing at which the stacking unit expands or contracts in the conveyance direction differs from a timing at which the stacking unit moves in the width direction.

Features of the present disclosure will become apparent from the following description of embodiments with reference to the attached drawings. The following description of embodiment is described by way of example.

### BRIEF DESCRIPTION OF THE DRAWINGS

FIG. 1 is a perspective view illustrating the internal configuration of a printing apparatus;

FIG. 2A and FIG. 2B are a front view and plan view of a printing part;

FIG. 3A and FIG. 3B are diagrams describing the conveyance system of the printing part;

FIG. 4 is a block configuration diagram focusing on the control system of a stacking part in the printing part;

FIG. 5 is a perspective configuration diagram of the stacking part;

FIG. 6A and FIG. 6B are diagrams describing the range of movement of a second stacking part;

FIG. 7A and FIG. 7B are diagrams describing the sorting positions of the stacking part;

FIG. 8 is a perspective configuration diagram of a drive transmission part;

FIG. 9 is a perspective configuration diagram of a cam;

FIG. 10A to FIG. 10C are diagrams describing the movement of a reciprocating member using the cam;

FIG. 11 is a diagram describing how the stacking part is driven, depending on the rotation direction of a drive source;

FIG. 12 is a diagram showing a relation between FIGS. 12A and 12B;

FIGS. 12A and 12B are flowcharts illustrating details of processing of print processing;

FIG. 13A to FIG. 13F are diagrams illustrating the states of the stacking part that has been driven during the printing processing;

FIG. 14A and FIG. 14B are diagrams describing a configuration for supporting the stacking part;

FIG. 15 is a perspective configuration diagram of a drive train;

FIG. 16A to FIG. 16D are schematic configuration diagrams of a delay gear;

FIG. 17A and FIG. 17B are diagrams describing the movement of a second support member via a pinion;

FIG. 18A to FIG. 18E are schematic configuration diagrams of a one-way clutch;

FIG. 19A to FIG. 19C are schematic configuration diagrams of a gear part;

FIG. 20A to FIG. 20H are diagrams describing the movement of the reciprocating member using a rotation of the cam;

FIG. 21A to FIG. 21H are diagrams describing the movement of the reciprocating member using a rotation of the cam;

FIG. 22A to FIG. 22C are diagrams illustrating the transmission of a driving force using the drive train; and

FIG. 23A and FIG. 23B are diagrams illustrating a modification example of a mechanism for moving the stacking part in the X direction.

### DESCRIPTION OF THE EMBODIMENTS

Hereinafter, with reference to the accompanying drawings, detailed descriptions are given of examples of an embodiment of the printing apparatus. Note that the following embodiments are not intended to limit the present disclosure, and every combination of the characteristics described in the present embodiments is not necessarily essential to the solution provided in the present disclosure. Further, the positions, shapes, etc., of the constituent elements described in the embodiments are merely examples and are not intended to limit the scope of this disclosure thereto.

In the following description, a printing apparatus equipped with a stacking device is described as an example of the stacking device according to the present embodiment. As an example of the printing apparatus equipped with the stacking device according to the present embodiment, a description is given of a multifunction peripheral that has a printing function for ejecting ink as a printing agent using an inkjet system to perform printing on a print medium and a reading function for reading a document placed on a platen glass. Note that the printing system is not limited to the inkjet system, and may be, for example, electrophotographic system or various other known systems. Printing agents that can be ejected by the printing apparatus according to the present embodiments are not limited to ink, and include various known printing agents used for printing, such as a processing liquid for applying a predetermined treatment to the ejected ink.

In the present specification, viewing from a position facing the side to which print media are discharged after printing, the direction from the left side toward the right side of the printing apparatus is described as the X direction, the direction from the rear side (the back side) toward the near side (the front side) of the printing apparatus is described as the Y direction, and the direction from the lower side toward the upper side of the printing apparatus is described as the Z direction. In this way, the X direction, Y direction, and Z direction are directions from one side toward the other side, and are orthogonal to one another. In the present specification, each direction is represented with a “+ (plus)” in a case where movement is from the one side toward the other side, and with a “− (minus)” in a case where movement is from the other side toward the one side, as appropriate.

### (Configuration of the Printing Apparatus)

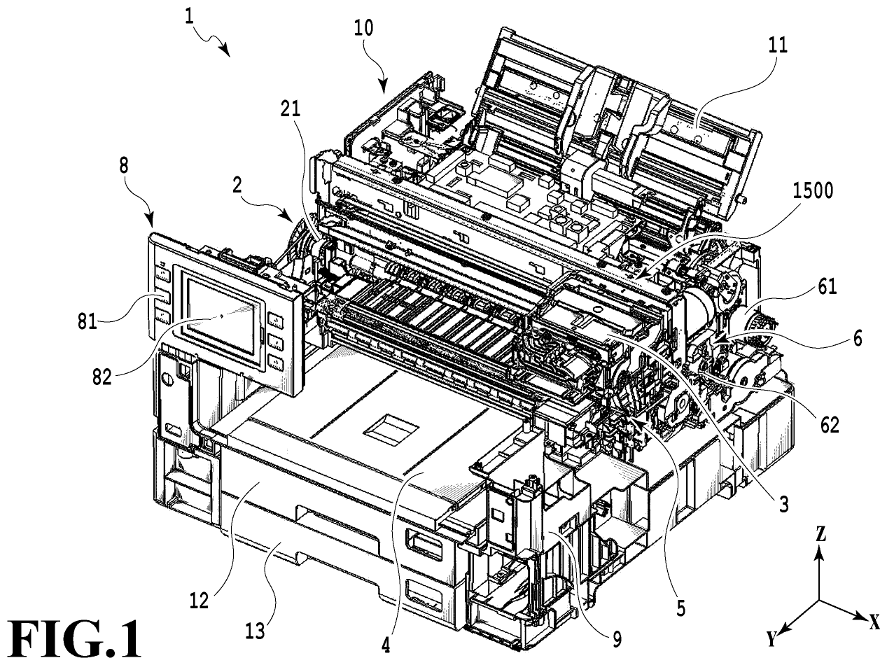

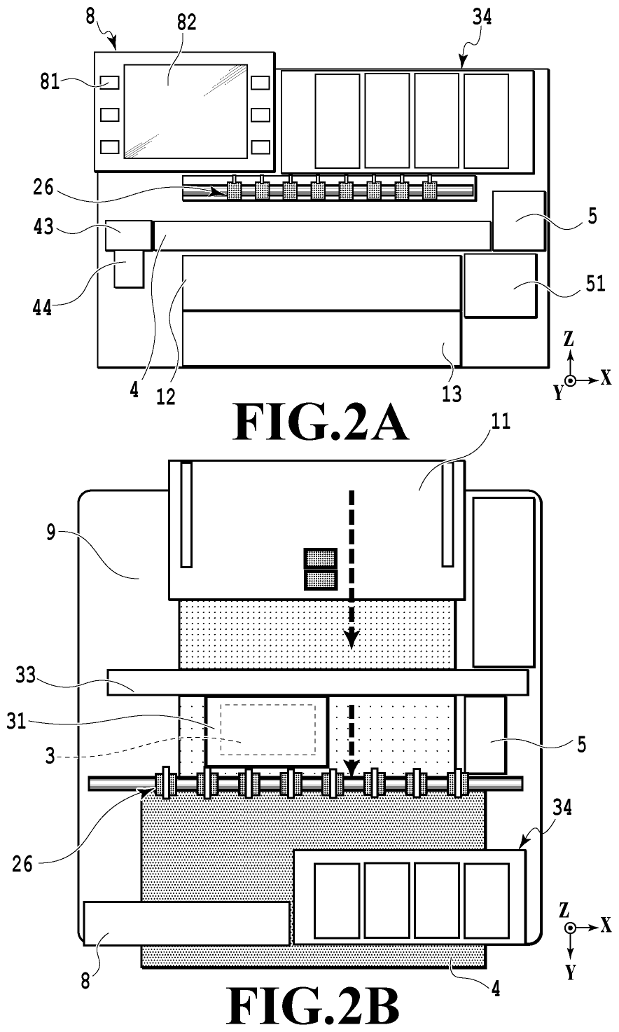

FIG. 1 is a perspective view of the internal configuration of the printing apparatus. FIG. 2A is a front view of a printing part, and FIG. 2B is a plan view of the printing part. Note that in FIG. 1, illustrations of some configurations are omitted for ease of understanding.

The printing apparatus 1 is a multifunction peripheral including the printing part 10 that performs printing on print media, and a scanner part (not illustrated in the drawings) arranged above the printing part 10 to read documents. In the printing apparatus 1, various processes related to a printing operation and reading operation are executed either individually or cooperatively by the printing part 10 and the scanner part.

The scanner part includes an ADF (automatic document feeder) and an FBS (flatbed scanner) and is capable of reading a document automatically fed by the ADF as well as reading a document placed on the platen glass of the FBS by the user. Note that although the printing apparatus 1 is a multifunction peripheral including the printing part 10 and the scanner part in the present embodiment, a form without the scanner part is also possible.

The printing part 10 includes the first paper feeding part 11, the second paper feeding part 12, and the third paper feeding part 13 for feeding print media (see FIG. 1). Further, the printing part 10 includes the conveyance part 2 that conveys print media fed from each paper feeding part, the print head 3 that performs printing by ejecting ink onto the print media conveyed by the conveyance part 2, and the stacking part 4 for stacking the print media after printing. Furthermore, the printing part 10 includes the maintenance part 5 that performs maintenance of the print head 3, and the drive part 6 that drives the first paper feeding part 11, the second paper feeding part 12, the third paper feeding part 13, and the maintenance part 5.

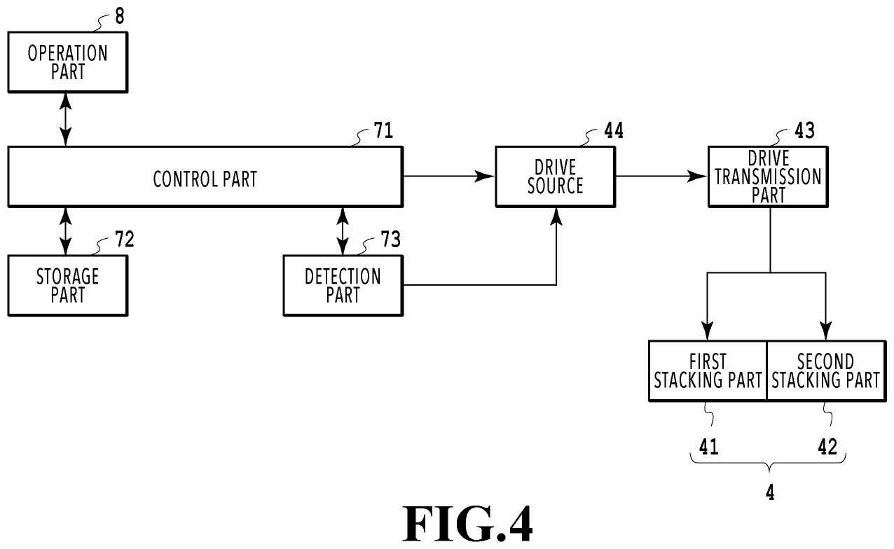

The printing part 10 includes the liquid storage part 34 for storing the ink to be supplied to the print head 3, and the ink discharge part 51 for storing the ink discharged from the maintenance part 5 (see FIG. 2A and FIG. 2B). Further, the printing part 10 includes the control part 71 (see FIG. 4) that controls the overall operation of the printing apparatus 1, such as the control of driving the conveyance part 2, the print head 3, the stacking part 4, and the drive part 6. Furthermore, the printing part 10 includes the operation part 8 capable of receiving input operations by the user and displaying various information. The operation part 8 is equipped with the operation button 81 for inputting operation information to the printing apparatus 1, and the display panel 82 for displaying operation information. In the printing apparatus 1, each of the above-described configurations is fastened to the housing 9 to constitute the printing part 10.

In the printing part 10, the operation part 8 and the liquid storage part 34 are arranged above the stacking part 4. More specifically, the operation part 8 and the liquid storage part 34 are each arranged at positions partially overlapping the stacking part 4 in the XY plane (see FIG. 2B). Note that the operation part 8 and the liquid storage part 34 are arranged with a space from the stacking part 4 in the Z direction (see FIG. 2A). In the present embodiment, the operation part 8 is arranged on one side (the left side) in the X direction, and the liquid storage part 34 is arranged on the other side (the right side) in the X direction. Note that it is also possible that the layout of the operation part 8 and the liquid storage part 34 in the X direction is reversed.

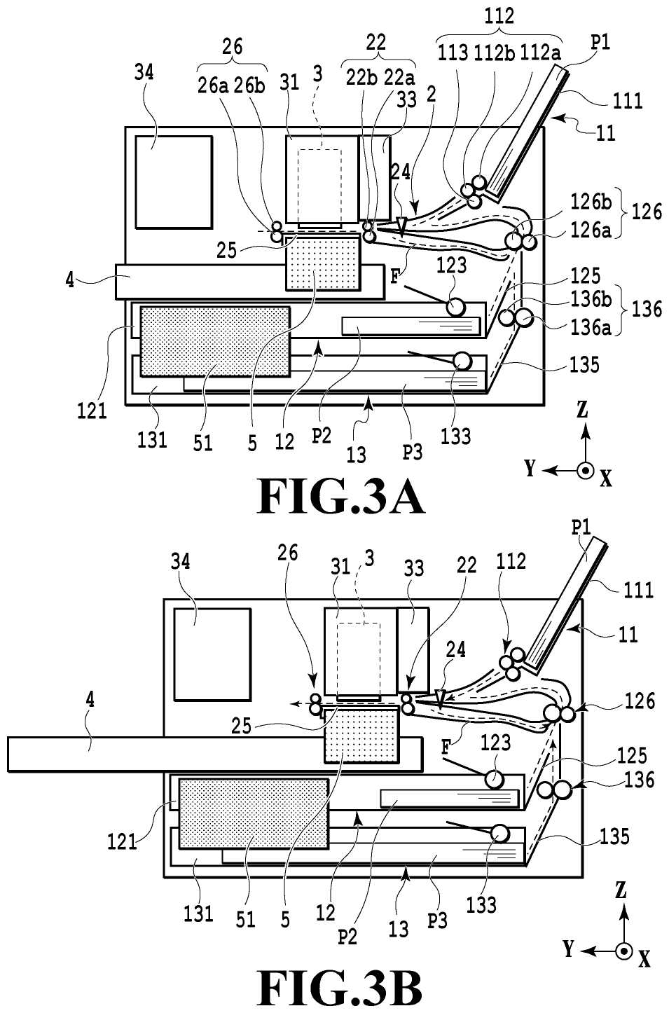

Further, in the printing part 10, the operation part 8 and the liquid storage part 34 are arranged on the other side in the Y direction (the front side) relative to the paper discharge roller pair 26, i.e., on the downstream side in the conveyance direction of print media to be discharged by the paper discharge roller pair 26. Additionally, in the printing part 10, the maintenance part 5 is arranged within the movement area of the print head 3, on the other side of the stacking part 4 in the X direction. More specifically, the maintenance part 5 is arranged at a position partially overlapping with the stacking part 4 in the YZ plane (see FIG. 3A). Furthermore, in the printing part 10, the ink discharge part 51 is arranged below the stacking part 4. More specifically, the ink discharge part 51 is arranged at a position partially overlapping with the stacking part 4 in the XY plane (see FIG. 2A and FIG. 3A). Note that the liquid storage part 34 may be arranged so as to overlap with the paper discharge roller pair 26 in the Y direction. In this case, it becomes possible to downsize the printing apparatus 1 in the Y direction.

### (Conveyance Part and Paper Feeding Part)

Next, a description is given about the configuration of the conveyance system of the printing part 10. FIG. 3A and FIG. 3B are diagrams illustrating the configuration of the conveyance system of the printing part 10, with FIG. 3A illustrating the state before the stacking part 4 expands, and FIG. 3B illustrating the state after the stacking part expands.

### <Conveyance Part>

The conveyance part 2 includes the conveyance roller pair 22 that conveys the print medium fed from each paper feeding part to the printing position where printing can be performed by the print head 3, and the paper discharge roller pair 26 that discharges the print medium after printing is performed by the print head 3. The conveyance roller pair 22 includes the conveyance roller 22a that is driven by the conveyance motor 21 (see FIG. 1), and the pinch roller 22b that is in pressure contact and associates with the conveyance roller 22a. At the conveyance roller pair 22, the print medium is nipped and conveyed by the conveyance roller 22a and the pinch roller 22b. The paper discharge roller pair 26 includes the paper discharge roller 26a that is driven by the conveyance motor 21, and the spur 26b that is in pressure contact with the paper discharge roller 26a. At the paper discharge roller pair 26, the print medium is nipped and conveyed by the paper discharge roller 26a and the spur 26b.

Further, the conveyance part 2 includes the first intermediate roller pair 126 that conveys the print media fed from the second paper feeding part 12 and the third paper feeding part 13 to the conveyance roller pair 22, and the second intermediate roller pair 136 that conveys the print medium fed from the third paper feeding part 13 to the first intermediate roller pair 126. The first intermediate roller pair 126 includes the first intermediate roller 126a that is driven by the drive part 6, and the first driven roller 126b that is in pressure contact and associates with the first intermediate roller 126a. At the first intermediate roller pair 126, the print medium is nipped and conveyed by the first intermediate roller 126a and the first driven roller 126b. Further, the second intermediate roller pair 136 includes the second intermediate roller 136a that is driven by the drive part 6, and the second driven roller 136b that is in pressure contact and associates with the second intermediate roller 136a. At the second intermediate roller pair 136, the print medium is nipped and conveyed by the second intermediate roller 136a and the second driven roller 136b.

Note that after the print medium fed from each paper feeding part passes through the detection lever 24 located on the upstream side of the conveyance direction relative to the conveyance roller pair 22, the positions of the left and right front edges of the print medium in the width direction are aligned with the conveyance direction by the conveyance roller pair 22. That is, the skew of the print medium in the conveyance direction is corrected by the conveyance roller pair 22.

### <Paper Feeding Part>

### =First Paper Feeding Part=

The first paper feeding part 11 includes the pressure plate 111 on which a print medium is placed, and the first paper feeding roller part 112 that feeds the print medium placed on the pressure plate 111 to the conveyance roller pair 22. The first paper feeding roller part 112 includes the first paper feeding rollers 112a and 112b that feed the print medium to the conveyance roller pair 22. Further, the first paper feeding roller part 112 includes the separation roller 113 that is arranged at a position opposed to the first paper feeding roller 112b and applies resistance to the print medium fed by the first paper feeding roller 112b. The first paper feeding rollers 112a and 112b are driven by the driving force of the driving motor 61 (see FIG. 1) of the drive part 6.

In the first paper feeding part 11, the print medium P1 stacked on the pressure plate 111 abuts on the first paper feeding roller 112a, which rotates under the driving of the driving motor 61, thereby starting the feeding of the print medium P1. The print medium P1 fed by the first paper feeding roller 112a is fed by the first paper feeding roller 112b, which is arranged on the downstream side in the feeding direction relative to the first paper feeding roller 112a. At this time, only the topmost sheet of the print media P1 fed by the first paper feeding roller 112b is fed to the conveyance roller pair 22 by the separation roller 113, which is arranged at the position opposed to the first paper feeding roller 112b.

### Second Paper Feeding Part=

The second paper feeding part 12 includes the cassette case 121 that accommodates a print medium, the second paper feeding roller 123 that feeds the print medium accommodated in the cassette case 121, and the separation part 125 that applies resistance to the print medium fed by the second paper feeding roller 123. The second paper feeding roller 123 is driven by the driving force of the driving motor 62 of the drive part 6 (see FIG. 1) transmitted through a gear train (not illustrated in the drawings).

In the second paper feeding part 12, upon driving of the driving motor 62, the second paper feeding roller 123 rotates while abutting on the print medium P2 accommodated in the cassette case 121, thereby starting the feeding of the print medium P2 to the first intermediate roller pair 126. To the print medium P2 fed by the second paper feeding roller 123, resistance against the feeding direction is applied by the separation part 125. Accordingly, even if multiple print media P2 are fed by the second paper feeding roller 123, only the topmost sheet of the print media P2 is fed to the first intermediate roller pair 126 by the separation part 125. The print medium P2 fed to the first intermediate roller pair 126 is conveyed to the conveyance roller pair 22 by the first intermediate roller pair 126.

### Third Paper Feeding Part

The third paper feeding part 13 includes the cassette case 131 that accommodates a print medium, the third paper feeding roller 133 that feeds the print medium accommodated in the cassette case 131, and the separation part 135 that applies resistance to the print medium fed by the third paper feeding roller 133. The third paper feeding roller 133 is driven by the driving force of the driving motor 62 of the drive part 6 (see FIG. 1) transmitted through a gear train (not illustrated in the drawings).

In the third paper feeding part 13, upon driving of the driving motor 62, the third paper feeding roller 133 rotates while abutting on the print medium P3 accommodated in the cassette case 131, thereby starting the feeding of the print medium P3 to the second intermediate roller pair 136. To the print medium P3 fed by the third paper feeding roller 133, resistance against the feeding direction is applied by the separation part 135. Accordingly, even if multiple print media P3 are fed by the third paper feeding roller 133, only the topmost sheet of the print media P3 is fed to the second intermediate roller pair 136 by the separation part 135. The print medium P3 fed to the second intermediate roller pair 136 is conveyed to the conveyance roller pair 22 by the second intermediate roller pair 136 and the first intermediate roller pair 126.

### (Print Head)

Next, a description is given about the print head 3. In the printing part 10, the print head 3 is supported in a slidable manner on the chassis 33 extending in the X direction, and is mounted on the carriage 31 configured to be capable of reciprocal movement in the X direction (see FIG. 2B and FIG. 3A). Accordingly, the print head 3 is able to move reciprocally in the X direction via the carriage 31. The print medium conveyed by the conveyance roller pair 22 is supported by the platen 25 placed at the position opposed to the print head 3. Further, while moving in the X direction via the carriage 31, the print head 3 ejects ink onto the print medium supported by the platen 25 to perform printing.

In a case where printing is performed only on one side of the print medium, the print medium after printing is discharged to the stacking part 4 via the paper discharge roller pair 26. On the other hand, in a case where printing is performed on both sides of the print medium, the conveyance motor 21 is rotated in the reverse direction with the rear edge of the print medium, after printing on one side, being nipped by the paper discharge roller pair 26. Accordingly, the paper discharge roller pair 26 and the conveyance roller pair 22 rotate in the direction opposite to the rotation for conveying the print medium in the conveyance direction, so as to convey the print medium nipped at the rear edge by the paper discharge roller pair 26 to the reversal conveying path F. In the description provided herein, it is assumed that the rear edge of a print medium refers to the rear edge of a print medium in the conveyance direction (+Y direction), and the front edge of a print medium refers to the front edge of a print medium in the conveyance direction.

Then, once the front edge of the print medium conveyed to the reversal conveying path F passes through the conveyance roller pair 22, the conveyance motor 21 is switched to forward rotation. After that, upon passing through the detection lever 24 due to conveyance by the first intermediate roller pair 126, skew correction is performed again by the conveyance roller pair 22. Subsequently, the same operation as that for printing on one side of the print medium is performed, so that after printing on the other side of the print medium, the print medium printed on both sides is discharged to the stacking part 4 by the paper discharge roller pair 26.

Note that, although details are described later, in the present embodiment, the stacking part 4 where the print media discharged via the paper discharge roller pair 26 are stacked automatically expands in the +Y direction during printing (see FIG. 3B). Accordingly, the stacking part 4, most of which is inside the housing 9 before expansion, protrudes outside the housing 9, thereby ensuring the area to stably stack the discharged print media. Note that the stacking part 4 is detachable from the housing 9.

### (Stacking Part)

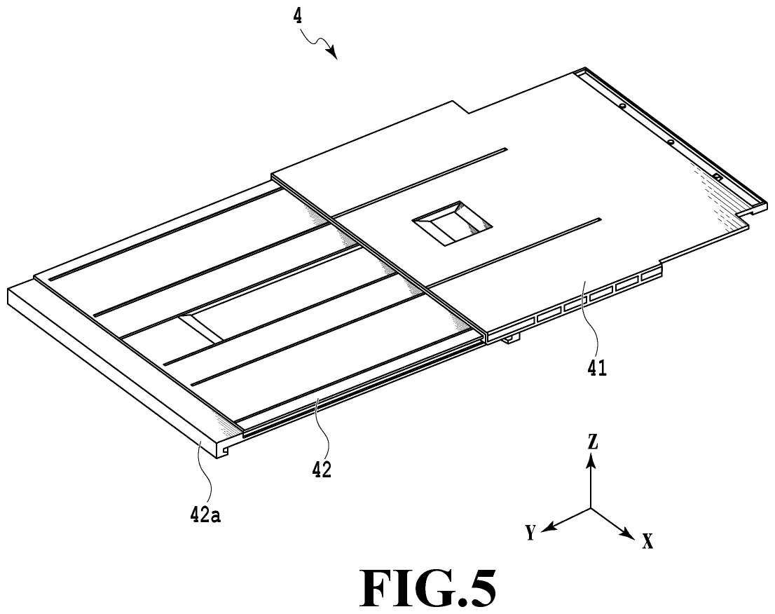

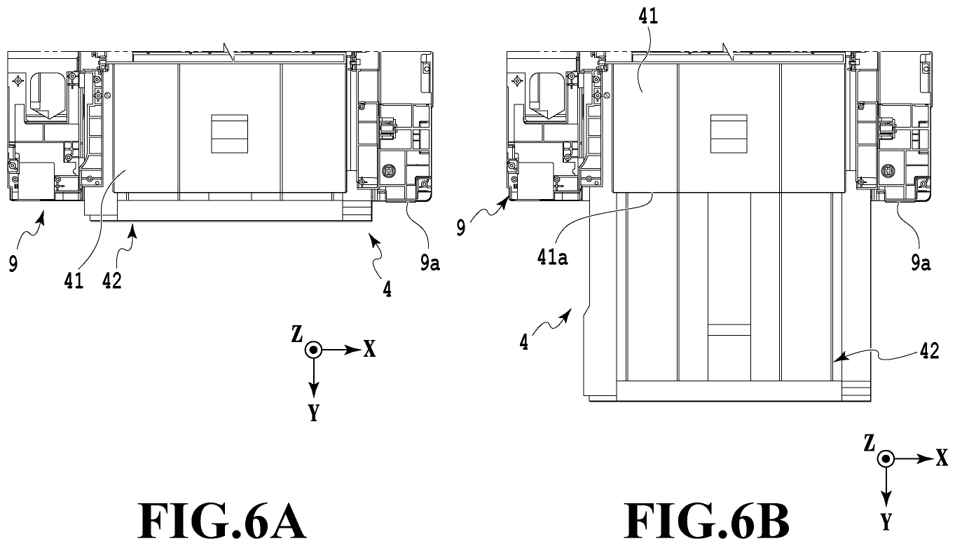

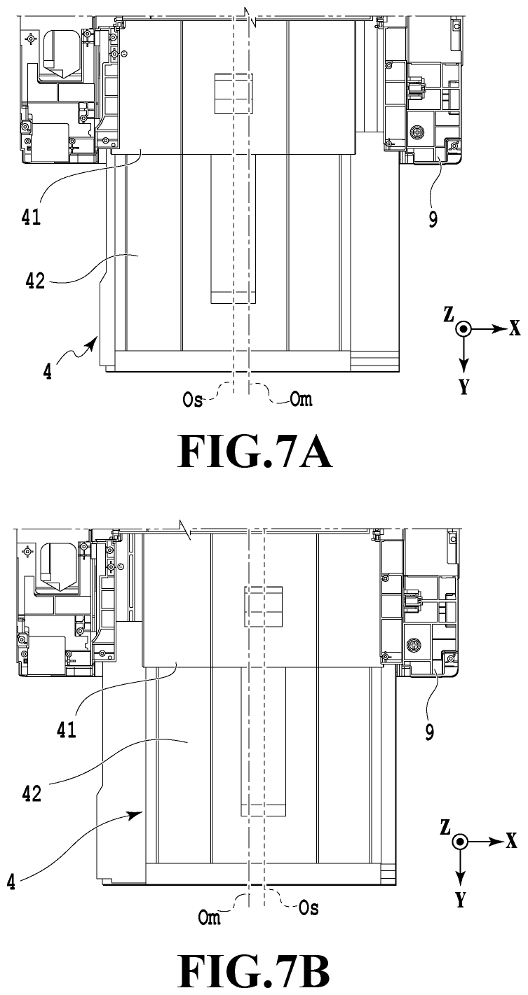

Next, a description is given about the stacking part 4. FIG. 4 is a block diagram illustrating the configuration of the control system of the printing apparatus 1. Note that, to focus on the stacking part 4 in the following description, the control configuration related to the stacking part 4 is mainly illustrated in FIG. 4, and other configurations are omitted. FIG. 5 is a perspective configuration diagram of the stacking part 4. FIG. 6A and FIG. 6B are diagrams illustrating the positions of the stacking part 4 after expansion and after contraction, with FIG. 6A illustrating the accommodated position of the second stacking part 42 after the stacking part 4 contracts, and FIG. 6B illustrating the stack position of the second stacking part 42 after the stacking part 4 expands. FIG. 7A and FIG. 7B are diagrams illustrating two sorting positions of the stacking part 4, with FIG. 7A illustrating the first sorting position, and FIG. 7B illustrating the second sorting position.

The stacking part 4 for stacking the print media discharged by the paper discharge roller pair 26 automatically expands upon the start of printing, thereby expanding the area that supports the discharged print media. Further, upon removal of the print media from the stacking part 4, the stacking part 4 automatically contracts, thereby reducing that area. Furthermore, the stacking part 4 has a function to move in a direction (the X direction) intersecting (orthogonally in the present embodiment) with the expansion and contraction direction (the Y direction) to sort the discharged print media. Note that the automatic contraction of the stacking part 4 in the printing part 10 is executed not only upon removal of the print media from the stacking part 4 but also upon receiving an instruction from the user via the operation part 8, upon absence of a printing operation for a predetermined time, upon switching to a low power mode, or the like. Further, it is also possible that the stacking part 4 is not contracted until an instruction is received from the user via the operation part 8.

The printing part 10 includes the control part 71, the storage part 72, the detection part 73, the operation part 8, the stacking part 4, the drive transmission part 43, and the drive source 44 (see FIG. 4).

During the time after receiving a printing command until the print medium is conveyed and discharged onto the stacking part 4, the control part 71 controls the stacking part 4 to complete the movement in the X direction and the expansion in the Y direction. Further, if the print media are removed from the stacking part 4, the control part 71 controls the stacking part 4 to start moving in the X direction and contracting in the Y direction. Although details are described later, the stacking part 4 is expanded after moving in the X direction to the first sorting position (which is described later). In the expansion of the stacking part 4, the second stacking part 42 that constitutes the stacking part 4 moves from the accommodated position (which is described later) to the stack position (which is described later). Further, the stacking part 4 is contracted after moving in the X direction to the second sorting position (which is described later) that is different from the first sorting position. In the contraction of the stacking part 4, the second stacking part 42 that constitutes the stacking part 4 moves from the stack position to the accommodated position. With this control, during discharge of a print medium, it is possible to reduce the influence of external force imposed on print media due to the movement of the stacking part 4. That is, it is possible to suppress deterioration in the alignment of the print media discharged and stacked, and thus while sorting print media, the visibility of the sorted print media is improved. Further, since the stacking part 4 automatically expands and contracts, there is no burden on the user, enhancing usability. Note that details of the driving control for the movement and expansion of the stacking part 4 by the control part 71 are described later.

The operation part 8 includes the operation button 81 and the display panel 82 (see FIG. 1). By operating the operation part 8, the user can select whether or not sorting of print media is required and issue an instruction for moving the stacking part 4. Note that in the printing part 10, sorting of print media and movement of the stacking part 4 can also be executed based on information set in a job, for example. The storage part 72 stores various programs for operating the stacking part 4. Upon input from the user through the operation part 8, the control part 71 reads the program corresponding to the input result to perform control of driving the stacking part 4. Further, the storage part 72 holds detection results from the detection part 73.

The detection part 73 includes multiple sensors. Specifically, a sensor that detects the rotation of the drive source 44 (see FIG. 2A) for driving the stacking part 4 is included. The sensor is configured with a rotary encoder and is installed on the rotary axis of the drive source 44 that generates a rotational driving force. The sensor converts the rotational angle of the drive source 44 into a number of steps and transmits it to the control part 71. The control part 71 reads, from the storage part 72, the number of steps required for a predetermined operation of the stacking part 4, and in a case where the number of steps transmitted from the sensor reaches the specified number of steps, the control part 71 determines that the predetermined operation of the stacking part 4 is completed and stops the drive source 44. In the present embodiment, the sensor is configured with an encoder installed on the rotary axis of the drive source 44; however, there is no such limitation. For example, installation on the rotary axis of a predetermined transmission member that constitutes the drive transmission part 43 (see FIG. 2A), which transmits the driving force of the drive source 44 to the stacking part 4, is also possible.

Further, the detection part 73 includes a sensor that detects the position of the stacking part 4 after the predetermined operation. As this sensor, for example, a mechanical switch, a photo sensor, or the rotary encoder of the drive source 44 may be used. Furthermore, the detection part 73 includes a sensor that detects whether or not any print medium is stacked on the stacking part 4. With this sensor, it is possible to detect the timing to contract the stacking part 4.

The stacking part 4 includes the first stacking part 41 and the second stacking part 42 (see FIG. 5). The first stacking part 41 is configured to be capable of reciprocal movement in the X direction, which intersects with the direction (the Y direction) in which print media are discharged. The first stacking part 41 is arranged within the housing 9, and the other end portion 41a in the Y direction is arranged further back in the Y direction relative to the front surface 9a of the housing 9 (see FIG. 6A).

The second stacking part 42 is supported by the first stacking part 41 and is configured to be capable of reciprocal movement in the Y direction in the first stacking part 41. Accordingly, the second stacking part 42 is able to reciprocally move in the X direction via the first stacking part 41.

The second stacking part 42 is configured to be movable between the accommodated position and the stack position (see FIG. 6A and FIG. 6B). The accommodated position is such that most of the second stacking part 42 overlaps with the first stacking part 41 in the XY plane and is accommodated below the first stacking part 41 (see FIG. 6A). The stack position is a position drawn out from the accommodated position so that the second stacking part 42 cooperates with the first stacking part 41 to be able to stack print media (see FIG. 6B). That is, at the time the stacking part 4 expands, the second stacking part 42 moves in the +Y direction from the accommodated position to the stack position. Further, at the time the stacking part 4 contracts, the second stacking part 42 moves in the −Y direction from the stack position to the accommodated position. Note that in the present embodiment, in the accommodated position, a partial area on the end portion 42a side of the second stacking part 42 protrudes in the Y direction relative to the front surface 9a of the housing 9. With this configuration, at the time the second stacking part 42 is in the accommodated position, most of the stacking part 4 is positioned inside the housing 9, thereby reducing the installation space of the printing apparatus 1.

Regarding the stack position, multiple different positions can be taken in the Y direction according to the size of the print media. In the present embodiment, as the stack position, four stack positions corresponding to A4, A5, B5, and LETTER sizes, respectively, can be taken. Note that the positions that can be taken as the stack position are not limited to these.

Further, by the movement of the first stacking part 41 in the X direction, the stacking part 4 is configured to be movable between two sorting positions for sorting the print media to be discharged. That is, in the X direction, the stacking part 4 can move between the first sorting position where the center position Os of the stacking part 4 is positioned on one side of the center position Om of the print media to be discharged (see FIG. 7A) and the second sorting position where the center position Os is positioned on the other side of the center position Om (see FIG. 7B). The stacking part 4 is configured to be capable of sorting the print media to be discharged at the positions offset from each other in the X direction by stacking the print media at the first sorting position and stacking the print media at the second sorting position. In other words, the first sorting position and the second sorting position are positioned a predetermined distance apart from each other in the X direction.

In the present embodiment, the distance from the center position Os to the center position Om at the first sorting position may be designed to match the distance from the center position Os to the center position Om at the second sorting position. Alternatively, it is also possible that the distance from the center position Os to the center position Om at the first sorting position is designed to differ from the distance from the center position Os to the center position Om at the second sorting position. The distance required for sorting, i.e., the distance between the first sorting position and the second sorting position, is set to be, for example, 30 mm or more and 50 mm or less. The positions where the stacking part 4 can stay are not limited to the first sorting position and the second sorting position. For example, it is also possible to adopt a configuration in which the stacking part 4 is positioned at the center position Om in a case where sorting is not performed during print processing, in a case where printing is not performed, or the like.

### (Drive Transmission Part)

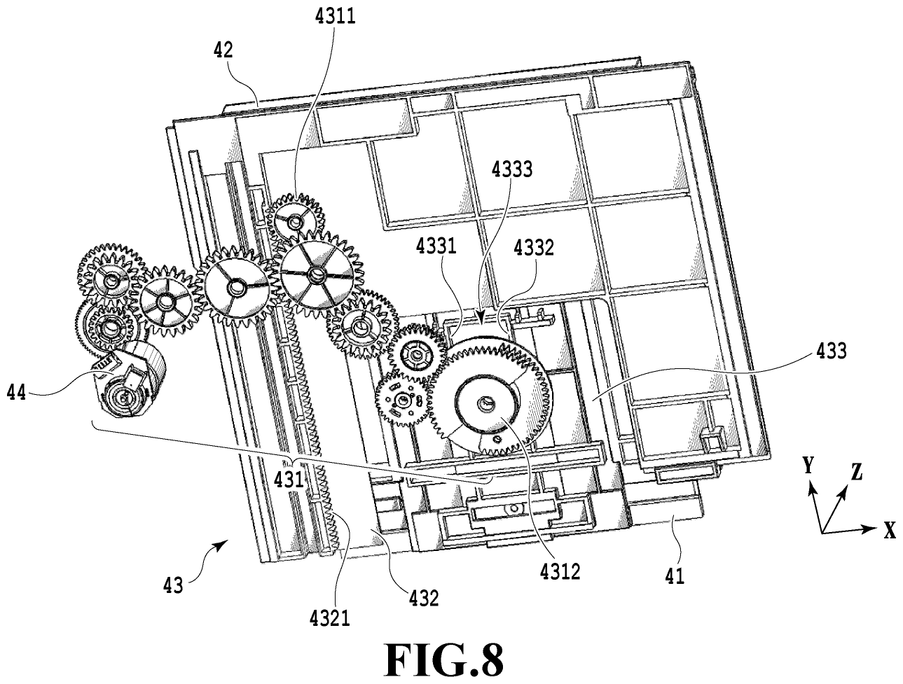

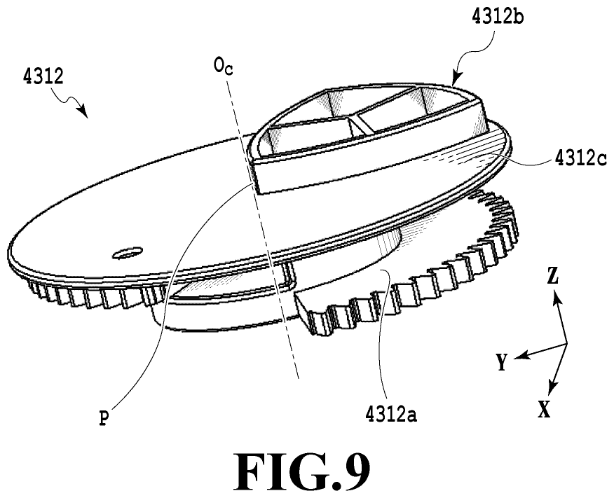

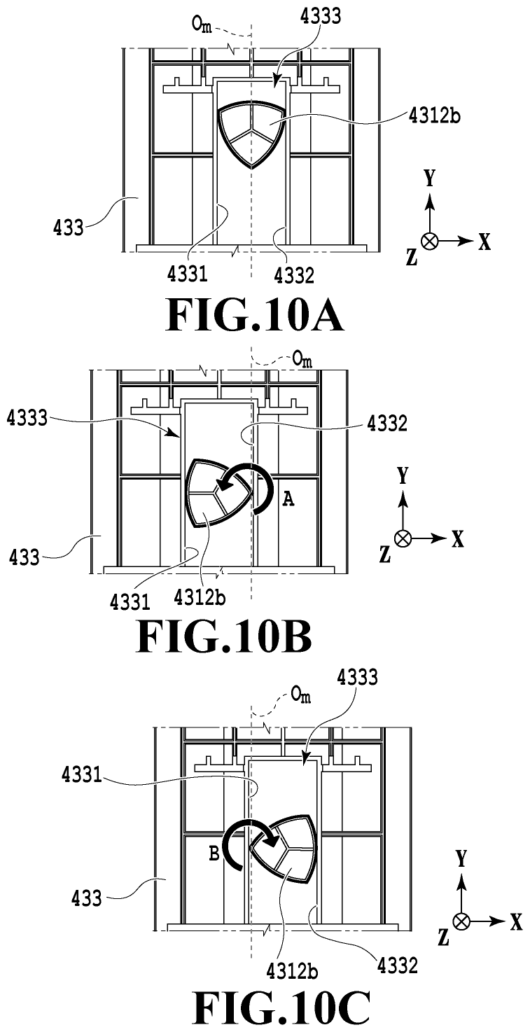

Next, a description is given of the drive transmission part 43. FIG. 8 is a perspective view of the drive transmission part 43. FIG. 9 is a perspective view of the cam, which is a constituent member of the drive transmission part 43. FIG. 10A to FIG. 10C are diagrams describing the movement of the stacking part 4 in the X direction using the cam.

The drive transmission part 43 includes the drive train 431 configured with multiple drive transmission members that transmit the rotational driving force from the drive source 44, and the support member 432 that can move in the Y direction by the driving force transmitted via the drive train 431 (see FIG. 8). Further, the drive transmission part 43 includes the reciprocating member 433 that is capable of moving in the X direction by the driving force transmitted via the drive train 431, and a casing (for example, the later-described tray gear cover 435) that holds the drive source 44 and the drive train 431.

The support member 432 includes the rack part 4321 that extends in the Y direction. This rack part 4321 meshes with the pinion 4311, which is one of the drive transmission members that constitute the drive train 431, thereby allowing the support member 432 to move in the Y direction by the driving force transmitted from the drive train 431. Specifically, the drive train 431 is configured with multiple gears, including the pinion 4311. The driving force transmitted from the drive source 44 is transmitted to the pinion 4311 via a predetermined gear in the drive train 431, causing the support member 432 to move in the Y direction due to the driving force transmitted to the pinion 4311. Note that the movement of the support member 432 via the drive train 431 is described in detail later.

One end of the drive train 431 is connected to the drive source 44. Further, at the other end of the drive train 431, the cam 4312 that engages with the reciprocating member 433 is positioned. Note that the detailed configuration of the drive train 431 and the details of drive transmission members that constitute the drive train 431 are described later. The cam 4312 includes the circular plate part 4312c, the gear part 4312a formed on one surface of the plate part 4312c, and the cam part 4312b formed on the other surface of the plate part 4312c (see FIG. 9). The driving force from the drive source 44 is transmitted to the gear part 4312a, thereby causing the cam 4312 to rotate about the rotational center, i.e., the axis Oc that passes through the center of the plate part 4312c and is parallel to the Z direction. In the present embodiment, the cam part 4312b has a substantially triangular cylindrical shape, and each side connecting adjacent vertices of the triangle is gently curved to protrude outward (see FIG. 10A). Further, the cam part 4312b is formed on the other surface of the plate part 4312c eccentrically with respect to the rotational center such that the predetermined vertex P is positioned on the axis Oc.

The reciprocating member 433 has the engagement part 4333 formed to engage with the cam part 4312b. The engagement part 4333 has the first sliding surface 4331 and the second sliding surface 4332 which are formed to face each other with a predetermined space in the X direction such that the engaging cam part 4312b can slide therein. Note that the predetermined space corresponds to the length of the cam part 4312b in the X direction. Further, the first sliding surface 4331 and the second sliding surface 4332 are formed parallel to the Y direction. As mentioned above, the cam part 4312b is eccentric with respect to the rotational center of the cam 4312. Accordingly, if the cam 4312 rotates, the cam part 4312b slides on the first sliding surface 4331 or the second sliding surface 4332, thereby moving the reciprocating member 433 in the +X direction or −X direction (see FIG. 10A to FIG. 10C).

For example, assume that, by a rotation of the cam 4312, the cam part 4312b has rotated from a predetermined position (the position illustrated in FIG. 10A) in the direction of arrow A (see FIG. 10B). In this case, the cam part 4312b slides on the first sliding surface 4331, thereby moving the reciprocating member 433 to one side (the −X direction) from the other side in the X direction (see FIG. 10B). Note that, as described in detail later, if the cam part 4312b further rotates in the direction of arrow A from the state illustrated in FIG. 10B, the cam part 4312b can move the reciprocating member 433 from one side to the other side (+X direction) in the X direction. In the present embodiment, the one drive source 44 is used to rotate the cam part 4312b in the direction of arrow A; however, an additional drive source (that is, a drive source other than the drive source 44) may be used to rotate the cam part 4312b in a direction other than the direction of arrow A. Assume that, in a configuration equipped with multiple drive sources, the cam part 4312b has rotated from a predetermined position in the direction of arrow B (see FIG. 10C) due to a rotation of the cam 4312. In this case, the cam part 4312b slides on the second sliding surface 4332, thereby moving the reciprocating member 433 from one side to the other side (+X direction) in the X direction (see FIG. 10C).

The support member 432 is connected to the second stacking part 42. Therefore, in conjunction with the movement of the support member 432 in the Y direction, the second stacking part 42 moves in the Y direction. Further, the reciprocating member 433 is connected to the first stacking part 41. Therefore, in conjunction with the movement of the reciprocating member 433 in the X direction, the first stacking part 41 moves in the X direction, and the second stacking part 42 also moves in the X direction via the first stacking part 41. In the present embodiment, the support member 432 is connected to the second stacking part 42 and the reciprocating member 433 is connected to the first stacking part 41; however there is no such limitation. For example, the rack part 4321 may be formed on the second stacking part 42, allowing the second stacking part 42 to have the function of the support member 432, or the engagement part 4333 may be formed on the first stacking part 41, allowing the first stacking part 41 to have the function of the engagement part 4333.

### (Overview of the Movements of the First Stacking Part and the Second Stacking Part)

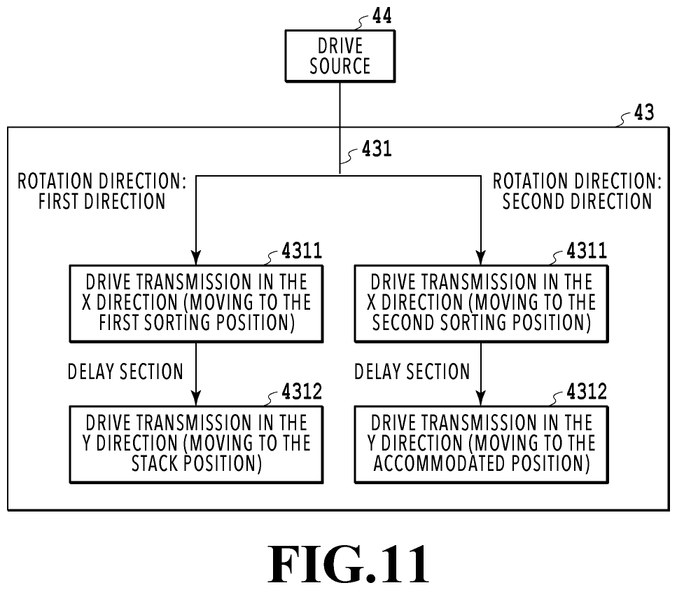

Next, a description is given of an overview of the movements of the first stacking part 41 and the second stacking part 42. FIG. 11 is a diagram illustrating an overview of the movements of the first stacking part 41 and the second stacking part 42.

In the drive train 431, a delay section is formed in the drive transmission path for the Y direction. Specifically, the drive train 431 is configured to start the movement of the second stacking part 42 in the Y direction after the movement of the first stacking part 41 in the X direction is completed. More specifically, in a case where the rotation direction of the drive source 44 is in the first direction, the first stacking part 41 is moved to the first sorting position, and the second stacking part 42 is also moved to the first sorting position via the first stacking part 41. Subsequently, the drive source 44 is further rotated in the first direction, thereby expanding the second stacking part 42 relative to the first stacking part 41, that is, the second stacking part 42 in the accommodated position is moved in the +Y direction to the stack position. In a case where the rotation direction of the drive source 44 is the second direction, which is opposite to the first direction, the first stacking part 41 is moved to the second sorting position, and the second stacking part 42 is also moved to the second sorting position via the first stacking part 41. Subsequently, the drive source 44 is further rotated in the second direction, thereby contracting the second stacking part 42 relative to the first stacking part 41, that is, the second stacking part 42 in the stack position is moved in the −Y direction to the accommodated position.

In the present embodiment, the drive transmission part 43 moves the second stacking part 42 in the Y direction after moving the first stacking part 41 in the X direction; however, there is no such limitation. For example, it is also possible to move the first stacking part 41 in the X direction after moving the second stacking part 42 in the Y direction. Further, various known transmission mechanisms, such as a link mechanism, may be used as a configuration for transmitting the driving force of the drive source 44. Furthermore, the printing part 10 may include multiple drive sources, so that the movement of the first stacking part 41 in the X direction and the movement of the second stacking part 42 in the Y direction are executed by the driving force from different drive sources. Note that the movement of the first stacking part 41 in the X direction and the movement of the second stacking part 42 in the Y direction may be executed not only by the drive source 44 but also manually by the user.

### (Print Processing)

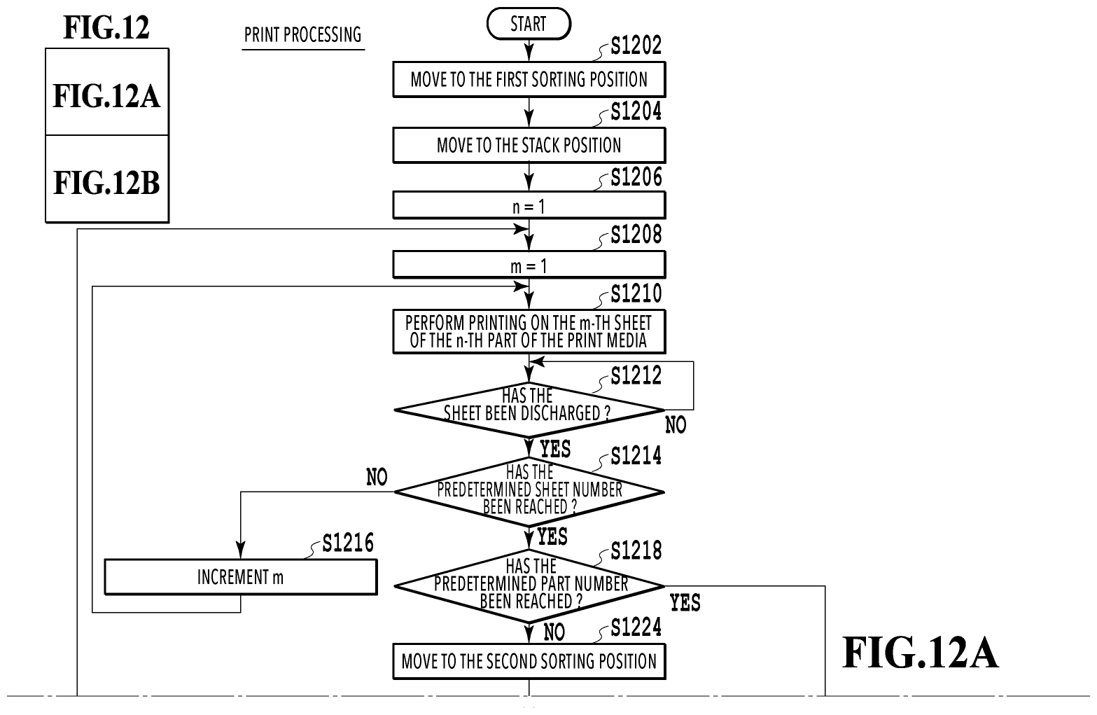

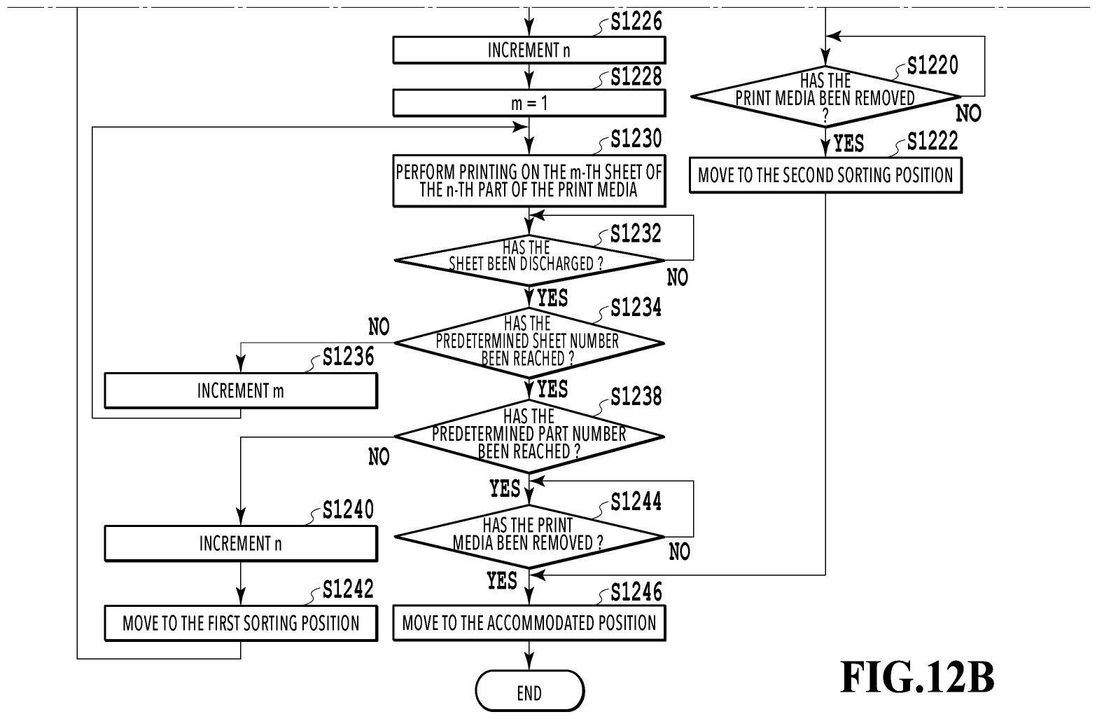

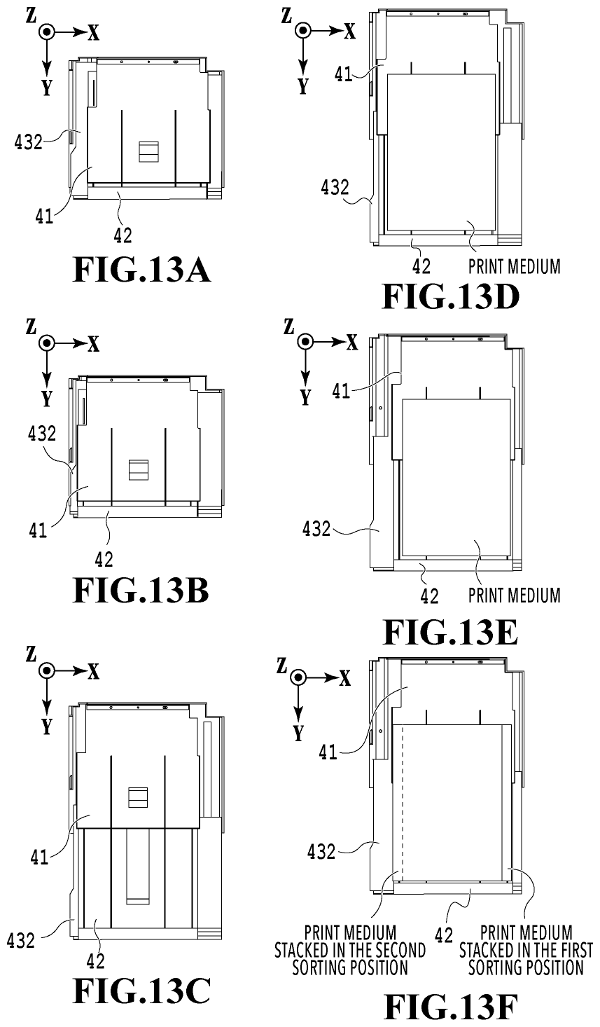

Next, a description is given about the print processing in which, while printing is performed on print media, the print media after printing are sorted in the stacking part 4. FIG. 12 is a flowchart illustrating the details of processing of the print processing in which, while printing is performed on print media, the print media after printing are sorted in the stacking part 4. FIG. 13A to FIG. 13F are diagrams illustrating the states after the stacking part 4 is moved. The series of processes illustrated in the flowchart of FIG. 12 is performed by the control part 71 loading a program code stored in a program memory (not illustrated in the drawings) of the storage part 72 into a data memory (not illustrated in the drawings) in the storage part 72 and executing it. Alternatively, part or all of the functions in the steps of FIG. 12 may be executed by hardware such as an ASIC (application-specific integrated circuit), an electronic circuit, or the like. In the present specification, the sign “S” in the description of each process in the flowchart indicates a step in the flowchart. Note that in the explanation of the print processing using FIG. 12, a case is described in which a bundle of M sheets of print media is treated as one part, and print processing is executed by the printing apparatus 1 based on a job for executing printing to generate N parts of such bundles of print media.

At the start of the print processing, first, in S1202, the control part 71 moves the first stacking part 41 and the second stacking part 42 to the first sorting position. In S1202, the drive source 44 is rotated in the first direction to move the first stacking part 41 and the second stacking part 42, which are at the initial position (see FIG. 13A), in the −X direction to the first sorting position (see FIG. 13B). Next, in S1204, the control part 71 moves the second stacking part 42 from the accommodated position to the stack position. In S1204, in the state where the first stacking part 41 and the second stacking part 42 are at the first sorting position, the drive source 44 is further rotated in the first direction, thereby moving the second stacking part 42 in the +Y direction from the accommodated position to the stack position (see FIG. 13C). In the present embodiment, the stack position changes according to the size of the print media. That is, in the present embodiment, the expansion amount of the stacking part 4 varies depending on the size of the print media. Therefore, in S1204, the stack position is determined based on a detection result of a sensor installed in the detection part 73 to detect the position of the stacking part 4 after a predetermined operation. Specifically, for example, based on a detection result of a rotary encoder of the drive source 44, the second stacking part 42 is moved to the stack position corresponding to the size of the print media. Alternatively, it is also possible to adopt a configuration in which the second stacking part 42 is moved to the stack position corresponding to the size of the print media based on a detection result of a mechanical switch, a photo sensor, or the like.

Note that, as described in detail later, the drive transmission part 43 is formed such that, in a state where the first stacking part 41 is at the first sorting position, the cam 4312 does not rotate any further even if the driving force resulting from the rotation of the drive source 44 in the first direction is transmitted. Therefore, in S1204, even if the drive source 44 rotates in the first direction in the state where the first stacking part 41 and the second stacking part 42 are at the first sorting position, the first stacking part 41 and the second stacking part 42 do not move in the −X direction from the first sorting position.

Next, in S1206, the control part 71 sets the variable n, which indicates the part number of the bundle of print media to be sorted, to “1.” Further, in S1208, the control part 71 sets the variable m, which indicates the sheet number of the print medium to be printed, to “1.” Then, in S1210, the control part 71 performs printing on the m-th sheet of the n-th part of the print media. In the printing part 10, a printing operation is performed in which ink is ejected while the print head 3 is moved in the X direction with respect to a predetermined area of the print media conveyed by the conveyance part 2 and supported by the platen 25. Next, after performing a conveying operation in which the conveyance part 2 conveys the print medium by a predetermined amount corresponding to the Y-direction length of the predetermined area, the printing operation is executed again. In this way, the printing part 10 performs printing on the print medium by alternately and repeatedly executing the printing operation and the conveyance operation. Therefore, the print medium is conveyed in the +Y direction during printing as the printing progresses, discharged at the end of the printing, and then stacked onto the stacking part 4, which has expanded to the first sorting position.

Then, in S1212, the control part 71 determines whether or not the print medium has been discharged. In S1212, for example, the determination is made based on a detection result of a sensor installed in the detection part 73 to detect the discharge of the print medium, and the number of discharged print media is counted. The discharged print medium is stacked onto the stacking part 4 at the first sorting position (see FIG. 13D).

In the present embodiment, the printing on the first sheet of the first part of print media is started after the first stacking part 41 and the second stacking part 42 are moved to the first sorting position and then the second stacking part 42 is moved to the stack position; however, there is no such limitation. The above-described movements of the first stacking part 41 and the second stacking part 42 only need to be completed by the time the first sheet of the first part of print media is discharged to the stacking part 4, and thus the movements and the printing on the first sheet of the first part of print media may be executed in parallel. Note that the phrase “by the time the first sheet of the first part of print media is discharged to the stacking part 4” refers, for example, to the time by which the first sheet of the first part of print media is discharged and placed onto the stacking part 4.

Thereafter, in S1214, whether or not the discharged print media have reached a predetermined number of sheets is determined. In S1214, whether or not the count of the discharged print media has reached a predetermined number of sheets, which is set in advance, is to be determined. Alternatively, in S1214, it is also possible to determine whether or not the sheet number m has reached a predetermined sheet number. In this case, in S1212, the count of the number of discharged print media is not performed. The predetermined sheet number is set based on information set in the job, for example. That is, in the present embodiment, the predetermined sheet number is “M,” and in S1214, whether or not m=M is to be determined.

In S1214, if it is determined that the discharged print media have not reached the predetermined number of sheets, the processing proceeds to S1216, where the control part 71 increments m, and the processing returns to S1210. Further, in S1214, if it is determined that the discharged print media have reached the predetermined number of sheets, the processing proceeds to S1218, where the control part 71 determines whether or not the part number n has reached a predetermined part number. The predetermined part number is set based on information set in the job, for example. That is, in the present embodiment, the predetermined part number is “N”, and in S1218, whether or not n=N is to be determined.

In S1218, if it is determined that the part number n has reached the predetermined part number, the processing proceeds to S1220, where the control part 71 determines whether or not the print media have been removed from the stacking part 4. In S1220, the determination is made based on a detection result of a sensor installed in the detection part 73 to detect whether or not any print medium is stacked on the stacking part 4. In S1220, if it is determined that the print media have not been removed from the stacking part 4, the processing of S1220 is performed again. At this time, it is also possible to provide, via the display panel 82 of the operation part 8, a notification that the printing has been completed to the user, a notification to prompt the user to remove the print media from the stacking part 4, etc. Further, in a case where the print media are not removed from the stacking part 4 by the user, the first stacking part 41 and the second stacking part 42 may be moved to an intermediate position between the first sorting position and the second sorting position. Further, in S1220, if it is determined that the print media have been removed from the stacking part 4, the processing proceeds to S1222, where the first stacking part 41 and the second stacking part 42 are moved to the second sorting position. In S1222, the drive source 44 is rotated in the second direction to move the first stacking part 41 and the second stacking part 42, which are at the first sorting position, in the +X direction to the second sorting position, and then the processing proceeds to S1246 described later.

Further, in S1218, if it is determined that the part number n has not reached the predetermined part number, the processing proceeds to S1224, where the control part 71 moves the first stacking part 41 and the second stacking part 42 to the second sorting position (see FIG. 13E). Since the details of processing of S1224 are the same as those of S1222 described above, the detailed explanations thereof are omitted. Next, in S1226, the control part 71 increments the variable n. Further, in S1228, the control part 71 sets the variable m to “1.” Thereafter, in S1230, the control part 71 performs printing on the m-th sheet of the n-th part of the print media. The print medium is conveyed in the +Y direction during printing as the printing progresses, discharged at the end of the printing, and then stacked onto the stacking part 4, which has expanded to the second sorting position. Then, in S1232, the control part 71 determines whether or not the print medium has been discharged. Note that the herein-discharged print medium is to be stacked onto the print medium stacked in the stacking part 4 at the first sorting position, i.e., to be stacked at a position offset in the X direction relative to the print media stacked at the first sorting position (see FIG. 13F).

In the present embodiment, the printing on the first sheet of the n-th part of the print media is performed after the first stacking part 41 and the second stacking part 42 are moved to the second sorting position; however, there is no such limitation. The movements of the first stacking part 41 and the second stacking part 42 to the second sorting position only need to be completed by the time the first sheet of the n-th part of the print media is discharged to the stacking part 4, and thus the movements and the printing on the first sheet of the n-th part of the print media may be executed in parallel. Note that the phrase “by the time the first sheet of the n-th part of the print media is discharged to the stacking part 4” refers, for example, to the time by which the first sheet of the n-th part of the print media is discharged and placed onto the print medium stacked on the stacking part 4.

Thereafter, in S1234, whether or not the discharged print media have reached the predetermined number of sheets is determined. In S1234, if it is determined that the discharged print media have not reached the predetermined number of sheets, the processing proceeds to S1236, where the control part 71 increments m, and the processing returns to S1230. Further, in S1234, if it is determined that the discharged print media have reached the predetermined number of sheets, the processing proceeds to S1238, where the control part 71 determines whether or not the part number n has reached a predetermined part number. Note that since the specific details of processing of S1232 through S1238 described above are the same as those of S1212 through S1218 described above, the detailed explanations thereof are omitted.

In S1238, if it is determined that the part number n has not reached the predetermined part number, the processing proceeds to S1240, where the control part 71 increments n. Then, in S1242, the control part 71 moves the first stacking part 41 and the second stacking part 42 to the first sorting position, and the processing returns to S1208. In S1242, the drive source 44 is rotated in the first direction to move the first stacking part 41 and the second stacking part 42, which are at the second sorting position, in the −X direction to the first sorting position.

In the present embodiment, after moving the first stacking part 41 and the second stacking part 42 to the first sorting position in S1242, the processing returns to S1208, where the printing on the first sheet of the n-th part of the print media is performed; however, there is no such limitation. The movements of the first stacking part 41 and the second stacking part 42 to the first sorting position in S1242 only need to be completed by the time the first sheet of the n-th part of the print media is discharged to the stacking part 4, and thus the movements and the printing on the first sheet of the n-th part of the print media may be executed in parallel.

Further, in S1238, if it is determined that the part number n has reached the predetermined part number, the processing proceeds to S1244, where the control part 71 determines whether or not the print media have been removed from the stacking part 4. Since the details of processing of S1244 are the same as those of S1220 described above, the detailed explanations thereof are omitted. In S1244, if it is determined that the print media have not been removed from the stacking part 4, the processing of S1244 is performed again. At this time, it is also possible to provide, via the display panel 82 of the operation part 8, a notification to prompt the user to remove the print media from the stacking part 4. In S1244, if it is determined that the print media have been removed from the stacking part 4, the processing proceeds to S1246, where the control part 71 moves the second stacking part 42 from the stack position to the accommodated position, and ends this print processing. Note that at the time of ending the print processing, for example, the first stacking part 41 and the second stacking part 42 in the accommodated position are moved to the initial position (see FIG. 13A).

In S1246, in the state where the first stacking part 41 and the second stacking part 42 are at the second sorting position, the drive source 44 is further rotated in the second direction, thereby moving the second stacking part 42 in the −Y direction from the stack position to the accommodated position. Note that, as described in detail later, the drive transmission part 43 is formed such that, in a state where the first stacking part 41 is at the second sorting position, the cam 4312 does not rotate any further even if the driving force resulting from the rotation of the drive source 44 in the second direction is transmitted. Therefore, in S1246, even if the drive source 44 rotates in the second direction in the state where the first stacking part 41 and the second stacking part 42 are at the second sorting position, the first stacking part 41 and the second stacking part 42 do not move in the +X direction from the second sorting position.

### (Detailed Configuration of the Drive Transmission Part 43)

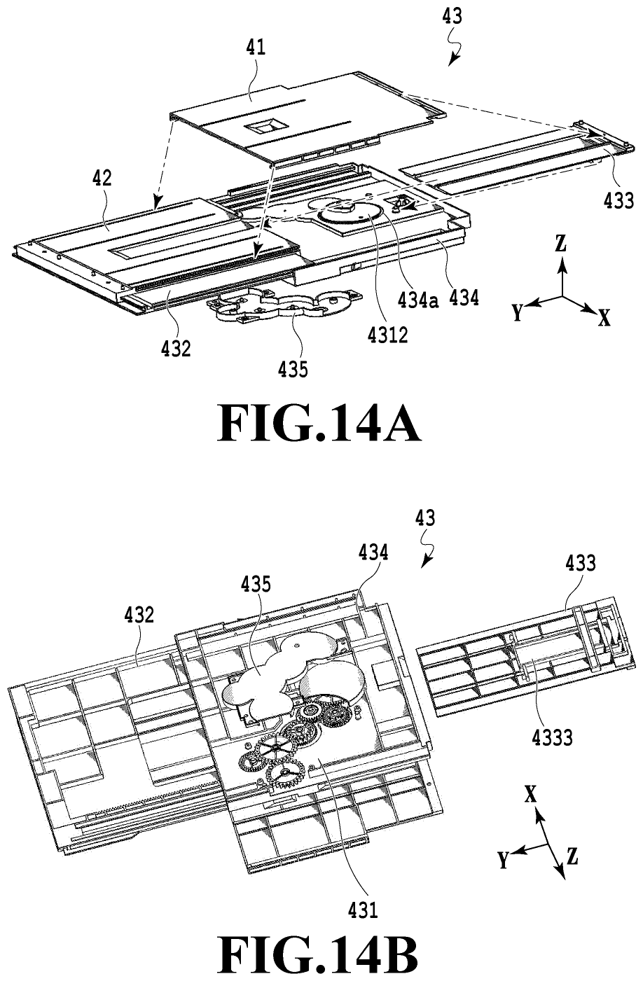

Next, a description is given about the detailed configuration of the drive transmission part 43. FIG. 14A and FIG. 14B are schematic configuration diagrams of the drive transmission part 43, with FIG. 14A being an exploded perspective view seen from above, and FIG. 14B being an exploded perspective view seen from below. The drive transmission part 43 includes the first support member 434 fixedly installed in the housing 9 of the printing part 10, and the second support member 432 movable in the Y direction relative to the first support member 434. Note that in the above description with reference to FIG. 8, the second support member 432 is described as the support member 432. Further, the drive transmission part 43 includes the reciprocating member 433 that moves the first stacking part 41 in the X direction, and the drive train 431 that transmits a driving force to the reciprocating member 433 and the second support member 432.

More specifically, on the first support member 434, the reciprocating member 433 is supported so as to be movable in the X direction. Further, in the first support member 434, the opening 434a into which the cam 4312 can fit is formed. The cam part 4312b (see FIG. 9) of the cam 4312 fitted into the opening 434a engages with the engagement part 4333 of the reciprocating member 433 supported by the first support member 434. On the reciprocating member 433, the first stacking part 41 is fixedly supported. Therefore, the first stacking part 41 is arranged so as to be movable in the X direction relative to the first support member 434 via the reciprocating member 433.

On the first support member 434, the second support member 432 is supported so as to be movable in the Y direction. On the second support member 432, the second stacking part 42 is supported so as to be movable in the X direction. Further, the second stacking part 42 is supported by the first stacking part 41 so as to be movable in the Y direction. Therefore, the second stacking part 42 is arranged so as to be movable in the X direction via the first stacking part 41 and movable in the Y direction via the second support member 432, relative to the first support member 434.

On the lower surface of the first support member 434, i.e., on the surface where the reciprocating member 433 and other members are not arranged, the drive train 431 is arranged so that the cam 4312 is fitted into the opening 434a. Note that, although illustration is omitted, on that lower surface, a shaft support part is installed for supporting the respective gears of the drive train 431 arranged thereon with shafts. The drive train 431 arranged on the lower surface of the first support member 434 is covered and protected by the tray gear cover 435.

### (Detailed Configuration of the Drive Train)

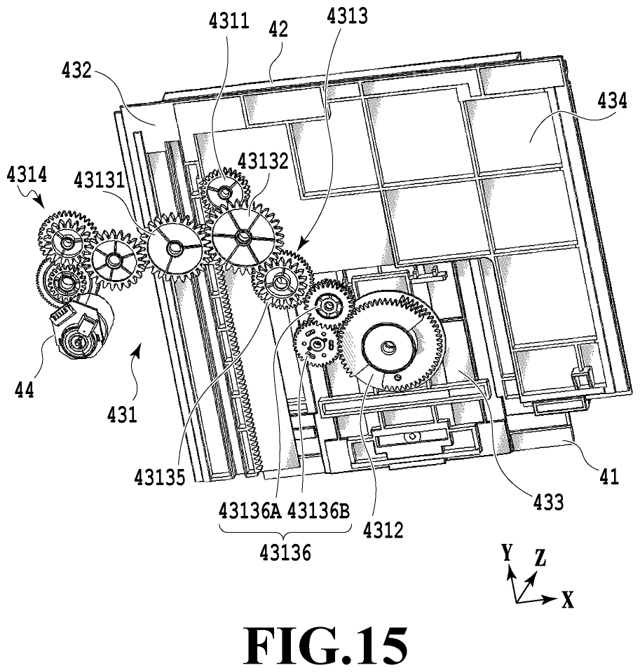

Next, a detailed description is given about the configuration of the drive train 431. FIG. 15 is a perspective view of the drive train 431. The drive train 431 is configured of two major gear trains. Specifically, the drive train 431 includes the first drive train 4314, which is a gear train connected to the drive source 44 fixed to the printing part 10, and the second drive train 4313 that transmits the driving force input from the output gear of the first drive train 4314 to the cam 4312. The second drive train 4313 includes the first tray gear 43131 to which the driving force is input from the output gear of the first drive train 4314, the delay gear 43132, the pinion 4311, the second tray gear 43135, the one-way clutch 43136, and the cam 4312.

The cam 4312 has the cam part 4312b which engages with the engagement part 4333 of the reciprocating member 433, and, with the rotation of the cam 4312, the reciprocating member 433 is moved in the X direction relative to the first support member 434. Note that the operation of the gears in the second drive train while the reciprocating member 433 moves is described later. The first stacking part 41 is fixedly supported by the reciprocating member 433, and thus moves in the X direction relative to the first support member 434 as the reciprocating member 433 moves. The second support member 432 includes the rack part 4321 that extends in the Y direction. The pinion 4311 rotates due to the driving force transmitted from the delay gear 43132, thereby allowing the second support member 432 to move in the Y direction.

### (Delay Gear)

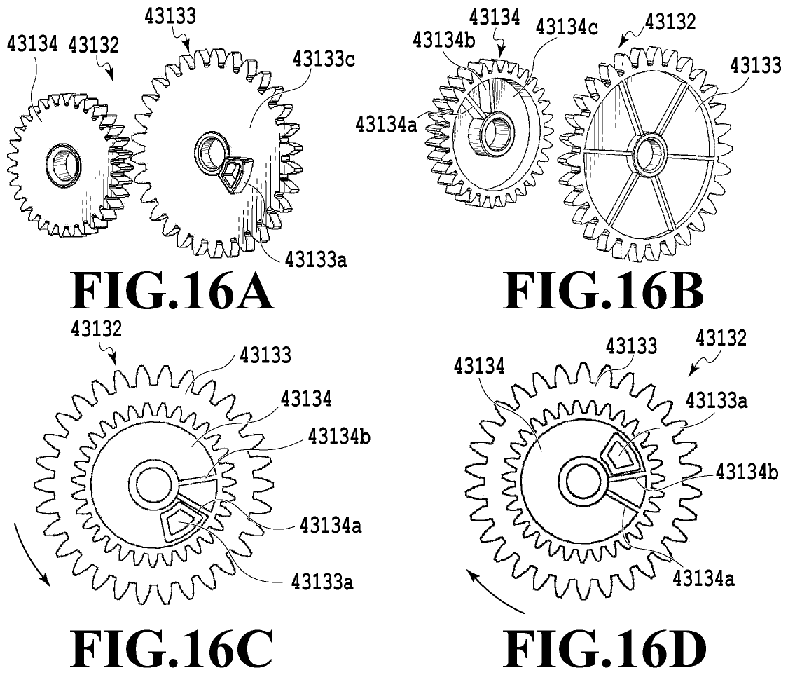

Next, a description is given about the configuration of the delay gear 43132. FIG. 16A to FIG. 16D are schematic configuration diagrams of the delay gear 43132. FIG. 16A is an exploded configuration diagram seen from one side. FIG. 16B is an exploded configuration diagram seen from the other side. FIG. 16C is a diagram illustrating an abutting state of a convex part and a rib while the second delay gear rotates in a predetermined direction. FIG. 16D is a diagram illustrating an abutting state of the convex part and a rib while the second delay gear rotates in the direction opposite to the predetermined direction. In FIG. 16C and FIG. 16D, for ease of understanding, the configuration of part of the second delay gear is made transparent to illustrate the convex part and the ribs.

The delay gear 43132 includes the first delay gear 43133 that meshes with the first tray gear 43131, and the second delay gear 43134 that is arranged coaxially with the first delay gear 43133 and meshes with the pinion 4311 (see FIG. 16A and FIG. 16B). The first delay gear 43133 has the convex part 43133a formed on the one surface 43133c facing the second delay gear 43134. Further, the second delay gear 43134 has, on the surface facing the first delay gear 43133, the concave part 43134c into which the convex part 43133a is fitted so as to be movable in a circumferential direction (see FIG. 16B). Further, in the second delay gear 43134, the two ribs 43134a and 43134b that abut on the moving convex part 43133a are formed in the concave part 43134c (see FIG. 16B).

The driving force of the drive source 44 is transmitted to the first tray gear 43131 via the first drive train 4314, and then to the first delay gear 43133 meshing with the first tray gear 43131 (see FIG. 15). At the time the first delay gear 43133 rotates in a predetermined direction (see the arrow in FIG. 16C), the second delay gear 43134 does not rotate until the convex part 43133a abuts on the rib 43134a. Further, once the first delay gear 43133 is rotated in the predetermined direction with the convex part 43133a abutting on the rib 43134a, the rib 43134a is pressed by the convex part 43133a (see FIG. 16C). Accordingly, the second delay gear 43134 rotates integrally with the first delay gear 43133 in the predetermined direction. Further, at the time the first delay gear 43133 rotates in the direction opposite to the predetermined direction (see the arrow in FIG. 16D), the second delay gear 43134 does not rotate until the convex part 43133a abuts on the rib 43134b. Furthermore, once the first delay gear 43133 is rotated in the opposite direction with the convex part 43133a abutting on the rib 43134b, the rib 43134b is pressed by the convex part 43133a (see FIG. 16D). Accordingly, the second delay gear 43134 rotates integrally with the first delay gear 43133 in the opposite direction.

### (Movement of the Second Support Member Via the Pinion)

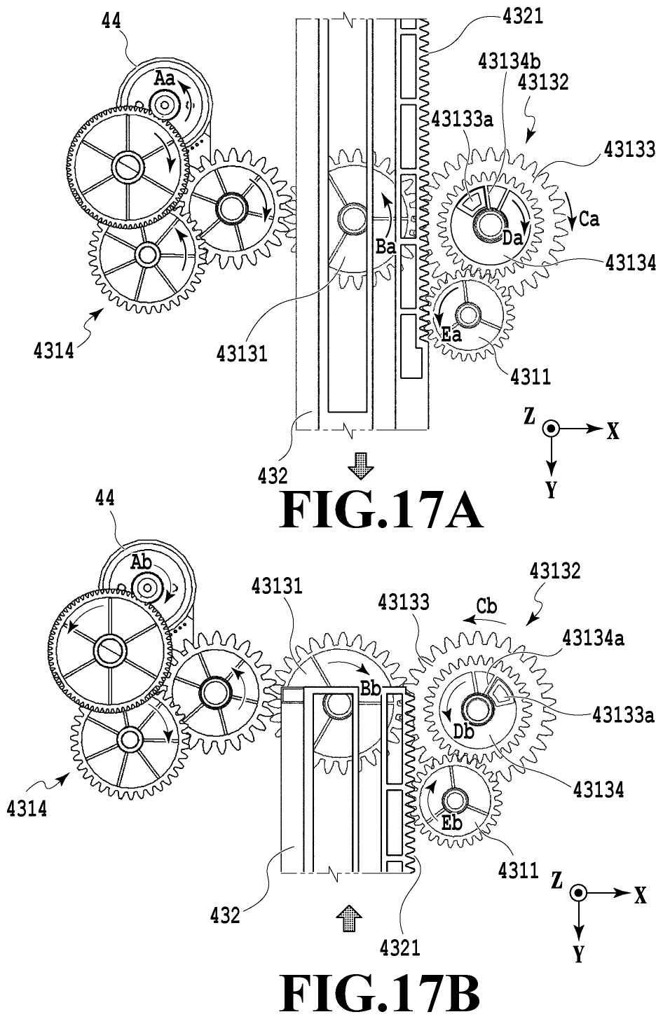

Next, a description is given about the movement of the second support member 432 via the pinion 4311. FIG. 17A and FIG. 17B are diagrams illustrating the movement of the second support member 432 via the pinion 4311. FIG. 17A is a diagram describing the transmission of the driving force at the time the second support member 432 moves in the +Y direction. FIG. 17B is a diagram describing the transmission of the driving force at the time the second support member 432 moves in the −Y direction.

If the drive source 44 rotates in the direction of arrow Aa, the driving force is transmitted to the first tray gear 43131 via the first drive train 4314, and the first tray gear 43131 rotates in the direction of arrow Ba (see FIG. 17A). Further, due to the rotation of the first tray gear 43131 in the direction of arrow Ba, the first delay gear 43133 rotates in the direction of arrow Ca. Then, after the convex part 43133a abuts on the rib 43134b of the second delay gear 43134, the second delay gear 43134 rotates integrally with the first delay gear 43133 in the direction of arrow Da.

The second delay gear 43134 meshes with the pinion 4311, and the pinion 4311 meshes with the rack part 4321. Therefore, upon the rotation of the second delay gear 43134 in the direction of arrow Da, the driving force is transmitted to the pinion 4311, causing the pinion 4311 to rotate in the direction of arrow Ea. Then, the rotation of the pinion 4311 in the direction of arrow Ea imparts the force to the rack part 4321 to move in the +Y direction. Since the rack part 4321 is installed on the second support member 432, the force imparted to the rack part 4321 causes the second support member 432 to move in the +Y direction. Note that, since the second stacking part 42 is supported by the second support member 432, the movement of the second support member 432 in the +Y direction also causes the second stacking part 42 to move in the +Y direction.

Further, if the drive source 44 rotates in the direction of arrow Ab, the driving force is transmitted to the first tray gear 43131 via the first drive train 4314, and the first tray gear 43131 rotates in the direction of arrow Bb (see FIG. 17B). Further, due to the rotation of the first tray gear 43131 in the direction of arrow Bb, the first delay gear 43133 rotates in the direction of arrow Cb. Then, after the convex part 43133a abuts on the rib 43134a of the second delay gear 43134, the second delay gear 43134 rotates integrally with the first delay gear 43133 in the direction of arrow Db.

Upon the rotation of the second delay gear 43134 in the direction of arrow Db, the driving force is transmitted to the pinion 4311, causing the pinion 4311 to rotate in the direction of arrow Eb. Then, the rotation of the pinion 4311 in the direction of arrow Eb imparts the force to the rack part 4321 to move in the −Y direction. The force imparted to the rack part 4321 causes the second support member 432, on which the rack part 4321 is installed, to move in the −Y direction, and the movement of the second support member 432 in the −Y direction causes the second stacking part 42 supported by the second support member 432 to move in the −Y direction. In this manner, in the present embodiment, the pinion 4311 and the rack part 4321 function as a transmission path that transmits the driving force for expanding and contracting the stacking part 4.

### (One-Way Clutch)

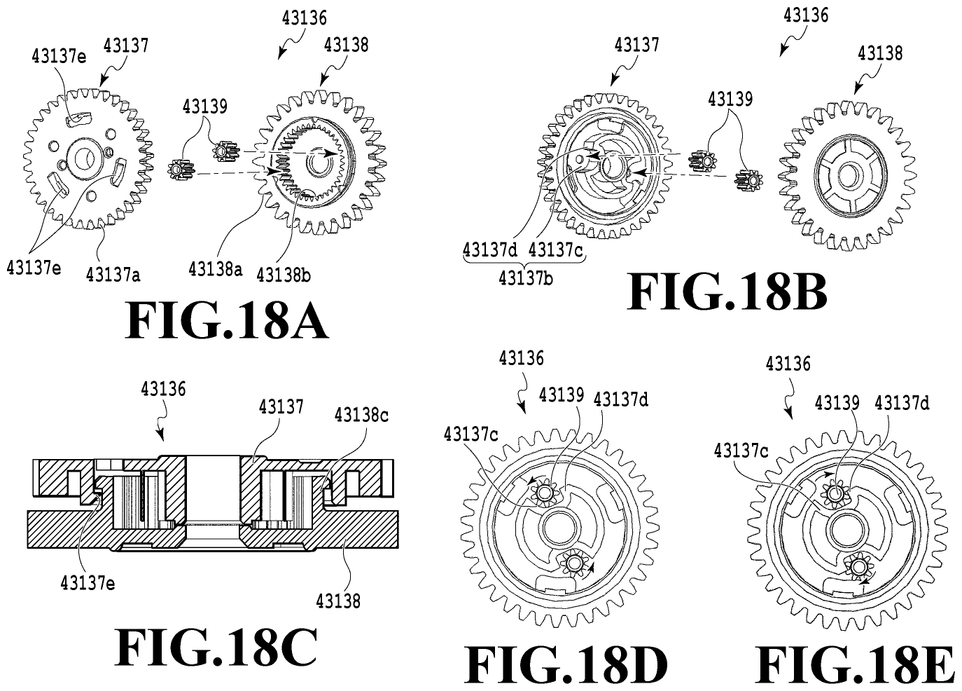

Next, a description is given about the configuration of the one-way clutch 43136. FIG. 18A to FIG. 18E are configuration diagrams of the one-way clutch 43136. FIG. 18A is an exploded configuration diagram seen from one side. FIG. 18B is an exploded configuration diagram seen from the other side. FIG. 18C is a cross-sectional view. FIG. 18D is a diagram describing idling of a planetary gear at an idling part. FIG. 18E is a diagram describing locking of the planetary gear at a locking part.

The one-way clutch 43136 is meshed with the gear part 4312a of the cam 4312 (see FIG. 9). The drive train 431 includes two one-way clutches 43136, with the one-way clutch 43136A being arranged upstream in the transmission direction of the driving force, and the one-way clutch 43136B being arranged downstream in that transmission direction (see FIG. 15). The one-way clutch 43136A meshes with the first sector gear 43121 (described later) of the gear part 4312a, and the one-way clutch 43136B meshes with the second sector gear 43122 (described later) of the gear part 4312a. Note that the one-way clutch 43136A and the one-way clutch 43136B have the same configuration.

Each of the one-way clutches 43136 includes the first input gear 43137, the first output gear 43138, and the planetary gears 43139 (see FIG. 18A and FIG. 18B). The first input gear 43137 includes the first input spur gear 43137a, and the receiving part 43137b that receives the planetary gears 43139.

The receiving part 43137b includes the idling part 43137c in which the received planetary gear 43139 rotates idly, and the locking part 43137d that locks the planetary gear 43139. The receiving part 43137b has a concave shape that is recessed so as to open radially outward (see FIG. 18B). The idling part 43137c is shaped so that the rotating planetary gear 43139 slides therein without meshing (see FIG. 18D). The locking part 43137d is shaped to mesh with a tooth of the planetary gear 43139, and regulates the rotation of the planetary gear 43139 (see FIG. 18E).

The first input gear 43137 includes the claw parts 43137e for connecting to the first output gear 43138 (see FIG. 18A and FIG. 18B). The claw parts 43137e engage with the engagement part 43138c formed in the first output gear 43138, thereby making the first input gear 43137 and the first output gear 43138 coaxially rotatable and connected so as not to separate from each other in a direction of the rotation axis.

The first output gear 43138 includes the first output spur gear 43138a and the first output internal gear 43138b that meshes with the planetary gears 43139. Upon the rotation of the planetary gear 43139 in a predetermined direction (see the arrow in FIG. 18D), the planetary gear 43139 rotates idly in the idling part 43137c, so that the driving force is not transmitted to the first output gear 43138 in which the first output internal gear 43138b meshes with the planetary gear 43139.

On the other hand, upon the rotation of the planetary gear 43139 in the direction opposite to the predetermined direction (see the arrow in FIG. 18E), a tooth of the planetary gear 43139 meshes with the locking part 43137d, and thus the planetary gear 43139 is locked to the locking part 43137d. Due to the locking of the planetary gear 43139 to the locking part 43137d, the driving force transmitted from the first input gear 43137 is transmitted to the first output gear 43138, and the first output gear 43138 rotates integrally with the first input gear 43137.

In the present embodiment, the one-way clutch 43136A and the one-way clutch 43136B have the same configuration; however, there is no such limitation, and for example, the number of teeth or the tooth width may be different. Further, the configuration of the one-way clutch 43136 is not limited to the configuration described above, and various known one-way transmission mechanisms, such as a spring clutch or a ratchet, may be used.

### (Gear Part)

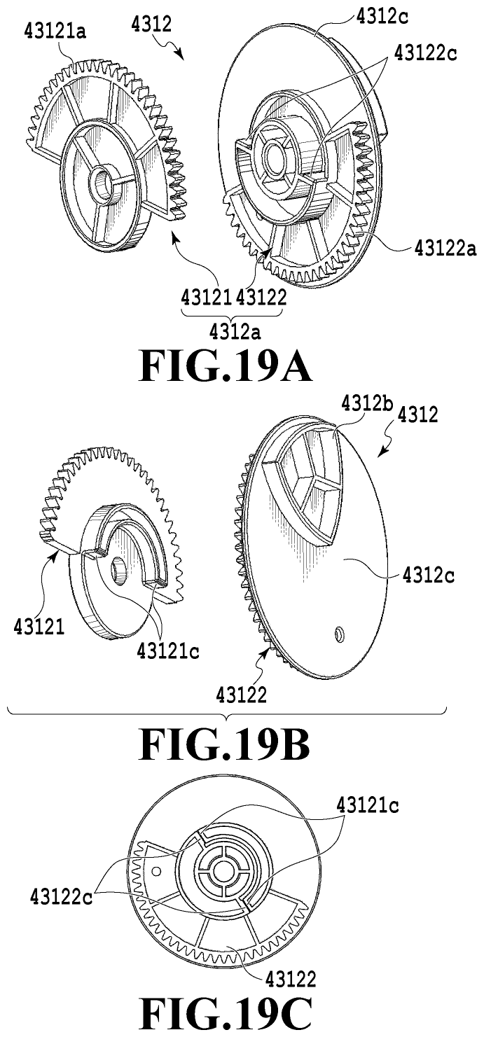

Next, a description is given about the configuration of the gear part 4312a (see FIG. 9) that meshes with the one-way clutch 43136. FIG. 19A to FIG. 19C are perspective configuration diagrams of the gear part 4312a of the cam 4312, with FIG. 19A being an exploded view seen from one side, FIG. 19B being an exploded view seen from the other side, and FIG. 19C being a diagram illustrating the abutting state of the abutment surfaces. Note that in FIG. 19C, illustration of some configurations of the first sector gear 43121 is omitted for ease of understanding.

The gear part 4312a of the cam 4312 includes the first sector gear 43121 and the second sector gear 43122 (see FIG. 19A). The first sector gear 43121 and the second sector gear 43122 are formed with part in their circumferential direction being toothless, such that the transmission of the driving force stops at the time the meshing with the corresponding gear (the first output gear 43138) is released. The first sector gear 43121 is equipped with the two abutment surfaces 43121c that intersect with the rotation direction (orthogonally in the present embodiment) (see FIG. 19B). Further, the second sector gear 43122 is equipped with the two abutment surfaces 43122c that intersect with the rotation direction (see FIG. 19A).

The second sector gear 43122 is, for example, formed integrally with the plate part 4312c, and the first sector gear 43121 is fixed to the plate part 4312c with the two abutment surfaces 43121c abutting on the two abutment surfaces 43122c of the second sector gear 43122 (see FIG. 19C). Accordingly, the first sector gear 43121 and the second sector gear 43122 can rotate together, and the driving force is transmitted to the cam 4312 via the first sector gear or the second sector gear, causing the cam 4312 to rotate.

Note that in the present embodiment, with respect to the circumferential direction of the gear part 4312a, the area in which the teeth 43121a of the first sector gear 43121 are formed and the area in which the teeth 43122a of the second sector gear 43122 are formed do not overlap with each other in the most part, but only in a partial area. Although the second sector gear 43122 is formed integrally with the plate part 4312c in the present embodiment, there is no such limitation, and the first sector gear 43121 may be formed integrally with the plate part 4312c.

Although the first sector gear 43121 and the second sector gear 43122 are configured as separate bodies, there is no such limitation, and the first sector gear 43121 and the second sector gear 43122 may be formed integrally. Furthermore, although the first sector gear 43121 and the second sector gear 43122 can rotate integrally by arranging the abutment surfaces 43121c and the abutment surfaces 43122c so as to abut on each other, there is no such limitation. For example, it is also possible to adopt a configuration in which the first sector gear 43121 and the second sector gear 43122 are fixed to each other using a pin or the like.

### (Rotation of the Cam)

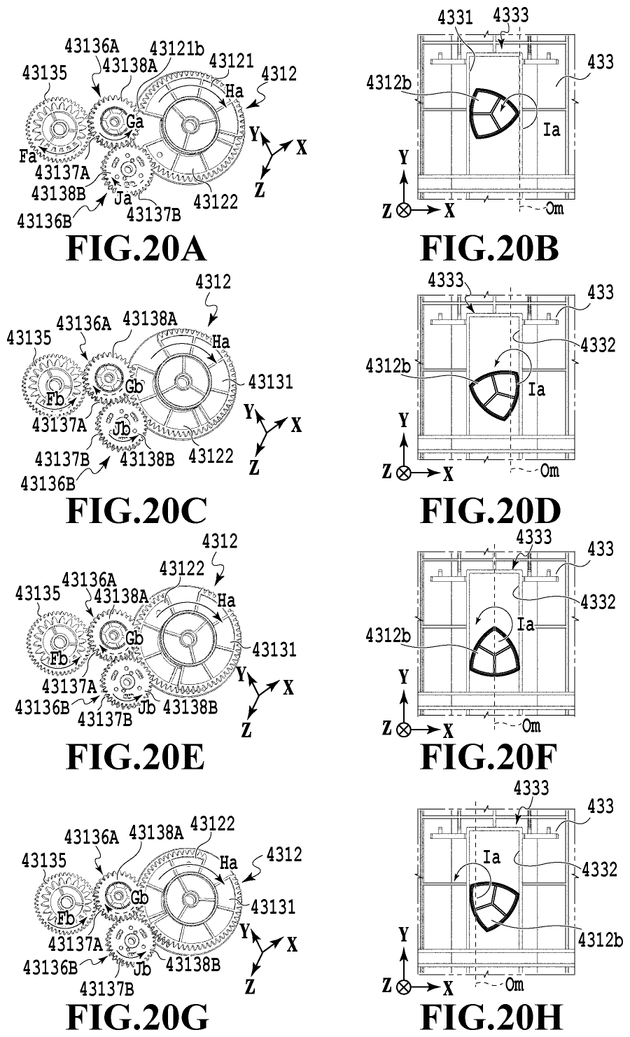

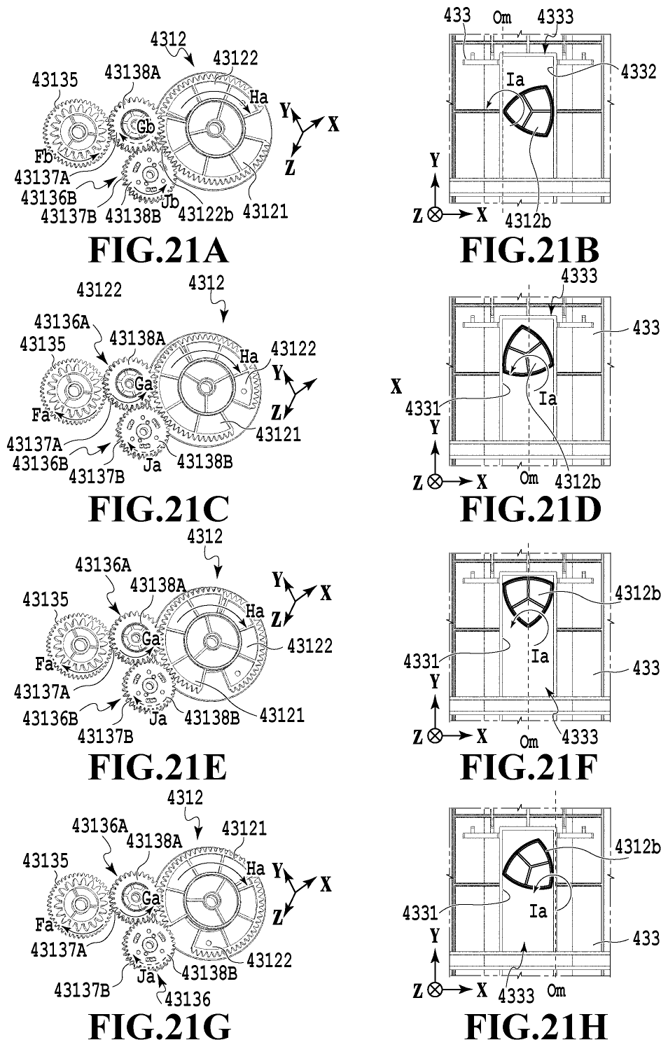

Next, a description is given about the rotation of the cam 4312 via the one-way clutches 43136 and the movement of the reciprocating member 433 due to this rotation. FIG. 20A to FIG. 20H and FIG. 21A to FIG. 21H are diagrams describing the movement of the reciprocating member 433 caused by the rotation of the cam 4312.

Of the two one-way clutches 43136 in the drive train 431, the one-way clutch 43136A located upstream in the transmission direction of the driving force has the first input gear 43137A meshing with the second tray gear 43135. Further, in the one-way clutch 43136A, the first output gear 43138A that is installed coaxially with the first input gear 43137A can mesh with the first sector gear 43121. On the other hand, of the two one-way clutches 43136 in the drive train 431, the one-way clutch 43136B located downstream in the transmission direction of the driving force has the first input gear 43137B meshing with the first input gear 43137. Further, in the one-way clutch 43136B, the first output gear 43138B that is installed coaxially with the first input gear 43137A can mesh with the second sector gear 43122.

Upon the rotation of the second tray gear 43135 in the direction of arrow Fa, the first input gear 43137A meshing with the second tray gear 43135 rotates in the direction of arrow Ga (see FIG. 20A). Then, due to the rotation of the first input gear 43137A in the direction of arrow Ga, the planetary gear 43139 is locked to the locking part 43137d (see FIG. 18E), and the first output gear 43138A rotates integrally with the first input gear 43137A in the direction of arrow Ga. Note that in the present embodiment, at the time the drive source 44 rotates in the direction of arrow Aa (see FIG. 17A), the second tray gear 43135 rotates in the direction of arrow Fa.

Due to the rotation of the first output gear 43138A in the direction of arrow Ga, the cam 4312 rotates in the direction of arrow Ha via the first sector gear 43121 meshing with the first output gear 43138A, thereby causing the cam part 4312b to rotate in the direction of arrow 1a (see FIG. 20B). Then, once the first sector gear 43121 finishes meshing with the first output gear 43138A up to the tooth 43121b located at the end of the rotation direction, the rotation of the cam 4312 in the direction of arrow Ha stops, and thus the rotation of the cam part 4312b in the direction of arrow 1a stops. Due to the rotation of the cam part 4312b in the direction of arrow 1a, the cam part 4312b slides on the first sliding surface 4331 of the engagement part 4333, and presses the first sliding surface 4331 in the −X direction. Accordingly, the reciprocating member 433 moves in the −X direction, so that in the X direction, the center of the reciprocating member 433 (the second stacking part 42) is positioned to one side (the left side) of the center position Om of the print media to be discharged (see FIG. 20B).

Further, due to the rotation of the first input gear 43137A in the direction of arrow Ga, the first input gear 43137B meshing with the first input gear 43137A rotates in the direction of arrow Ja. At this time, in the one-way clutch 43136B, the planetary gears 43139 are located in the idling part 43137c (see FIG. 18D), and thus the first input gear 43137B rotates idly with respect to the first output gear 43138B. Therefore, the rotation of the first input gear 43137B is not transmitted to the first output gear 43138B, and thus the driving force is not transmitted to the second sector gear 43122.

Note that, as the rotation of the cam 4312 in the direction of arrow Ha progresses, the second sector gear 43122 meshes with the first output gear 43138B. Then, as the cam 4312 further rotates in the direction of arrow Ha, the first output gear 43138B rotates via the second sector gear 43122 in the direction opposite to the rotation direction of the first input gear 43137B. At this time, in the one-way clutch 43136B, the planetary gears 43139 are located in the idling part 43137c. Therefore, the first output gear 43138B and the first input gear 43137B can rotate in the directions opposite to each other without any hindrance.

By finishing the meshing up to the tooth 43121b, the cam part 4312b can be stopped at the top dead center with respect to the first sliding surface 4331 of the reciprocating member 433 (see FIG. 20B). With this configuration, even if a force is applied to the stacking part 4 in the X direction, the force that rotates the cam part 4312b is unlikely to be generated, and thus the stacking part 4 can be held in that position. In the present embodiment, at the time the cam part 4312b and the reciprocating member 433 are in the state illustrated in FIG. 20B, the stacking part 4 is located at the first sorting position. The operations described with reference to FIG. 20A and FIG. 20B is executed, for example, in the process of S1202 of the print processing.

Next, upon the rotation of the second tray gear 43135 in the direction of arrow Fb from the state illustrated in FIG. 20A, the first input gear 43137A rotates in the direction of arrow Gb (see FIG. 20C). At this time, in the one-way clutch 43136A, the planetary gears 43139 are located in the idling part 43137c, and thus the first input gear 43137A rotates idly with respect to the first output gear 43138A. Therefore, the rotation of the first input gear 43137A is not transmitted to the first output gear 43138A, and thus the driving force is not transmitted to the first sector gear 43121. Note that in the present embodiment, at the time the drive source 44 rotates in the direction of arrow Ab (see FIG. 17B), the second tray gear 43135 rotates in the direction of arrow Fb.

Further, due to the rotation of the first input gear 43137B in the direction of arrow Gb, the first input gear 43137B meshing with the first input gear 43137A rotates in the direction of arrow Jb. At this time, due to the rotation of the first input gear 43137B in the direction of arrow Jb, the planetary gears 43139 of the one-way clutch 43136B are locked to the locking part 43137d. Then, as the first input gear 43137B further rotates in the direction of arrow Jb, the first output gear 43138B rotates integrally with the first input gear 43137B in the direction of arrow Jb.

Due to the rotation of the first output gear 43138B in the direction of arrow Jb, the cam 4312 rotates in the direction of arrow Ha via the second sector gear 43122 meshing with the first output gear 43138B, thereby causing the cam part 4312b to rotate in the direction of arrow 1a (see FIG. 20D). Due to the rotation of the cam part 4312b in the direction of arrow 1a from the state illustrated in FIG. 20B, the cam part 4312b slides on the second sliding surface 4332 of the engagement part 4333, and presses the second sliding surface 4332 in the +X direction. Accordingly, the reciprocating member 433 is moved in the +X direction (see FIG. 20D).

Then, from the state illustrated in FIG. 20C, the further rotation of the second tray gear 43135 in the direction of arrow Fb causes the first output gear 43138B to further rotate in the direction of arrow Jb (see FIG. 20E). Accordingly, the cam part 4312b rotates in the direction of arrow 1a to move the reciprocating member 433 in the +X direction, so that in the X direction, the center of the reciprocating member 433 (the second stacking part 42) coincides with the center position Om (see FIG. 20F).

Further, from the state illustrated in FIG. 20E, the further rotation of the second tray gear 43135 in the direction of arrow Fb causes the first output gear 43138B to further rotate in the direction of arrow Jb (see FIG. 20G). Accordingly, the cam part 4312b rotates in the direction of arrow 1a, and the reciprocating member 433 further moves in the +X direction (see FIG. 20H). Thereafter, once the second sector gear 43122 finishes meshing with the first output gear 43138B up to the tooth 43122b located at the end of the rotation direction (see FIG. 21A), the rotation of the cam 4312 in the direction of arrow Ha stops. Accordingly, the rotation of the cam 4312 in the direction of arrow 1a stops, and the movement of the reciprocating member 433 in the +X direction stops (see FIG. 21B).

Once the second sector gear 43122 finishes meshing with the first output gear 43138B up to the tooth 43122b, even if the second tray gear 43135 rotates in the direction of arrow Fb thereafter, the driving force is no longer transmitted to the cam 4312 via the one-way clutch 43136A. On the other hand, due to the rotation of the cam 4312 in the direction of arrow Ha using the second sector gear 43122, the first sector gear 43121 comes into mesh with the first output gear 43138A (see FIG. 21A). At this time, in the one-way clutch 43136A, the planetary gears 43139 are located in the idling part 43137c, and thus the first output gear 43138A does not hinder the rotation of the first input gear 43137A.

As the second sector gear 43122 finishes meshing with the first output gear 43138 up to the tooth 43122b, the cam part 4312b can be stopped at the top dead center with respect to the second sliding surface 4332 of the reciprocating member 433 (see FIG. 21B). With this configuration, even if a force is applied to the stacking part 4 in the X direction, the force that rotates the cam part 4312b is unlikely to be generated, so that the stacking part 4 can be held in that position. In the present embodiment, at the time the cam part 4312b and the reciprocating member 433 are in the state illustrated in FIG. 21B, the stacking part 4 is located at the second sorting position. The operations described with reference to FIG. 20C to FIG. 21D are executed, for example, in the processes of S1222 and S1224 of the print processing.

Thereafter, upon the rotation of the second tray gear 43135 in the direction of arrow Fa from the state illustrated in FIG. 21A, as described above, the first output gear 43138A rotates integrally with the first input gear 43137A in the direction of arrow Ga (see FIG. 21C). Due to the rotation of the first output gear 43138A in the direction of arrow Ga, the cam 4312 rotates in the direction of arrow Ha via the first sector gear 43121, thereby causing the cam part 4312b to rotate in the direction of arrow 1a (see FIG. 21D). Due to this rotation of the cam part 4312b in the direction of arrow 1a, the cam part 4312b slides on the first sliding surface 4331, and presses the first sliding surface 4331 in the −X direction. Accordingly, the reciprocating member 433 is moved in the −X direction.

Then, from the state illustrated in FIG. 21C, the further rotation of the second tray gear 43135 in the direction of arrow Fa causes the first output gear 43138A to further rotate in the direction of arrow Ga (see FIG. 21E). Accordingly, the cam part 4312b rotates in the direction of arrow 1a to move the reciprocating member 433 in the −X direction, so that in the X direction, the center of the reciprocating member 433 (the second stacking part 42) coincides with the center position Om (see FIG. 21F). Thereafter, from the state illustrated in FIG. 21E, the further rotation of the second tray gear 43135 in the direction of arrow Fa causes the first output gear 43138A to further rotate in the direction of arrow Ga, so that the state transitions, via the state illustrated in FIG. 21G, to the state illustrated in FIG. 20A. Accordingly, the cam part 4312b rotates in the direction of arrow 1a, and thus the state transitions, via the state of FIG. 21H, to the state of FIG. 20B. The operations described with reference to FIG. 21C to FIG. 20A are executed, for example, in the process of S1242 of the print processing.

In this way, in the present embodiment, the second tray gear 43135, the one-way clutches 43136A and 43136B, and the cam 4312 function as a transmission path for transmitting the driving force for moving the stacking part 4 in the X direction.

### (Transmission of the Driving Force to the Pinion)

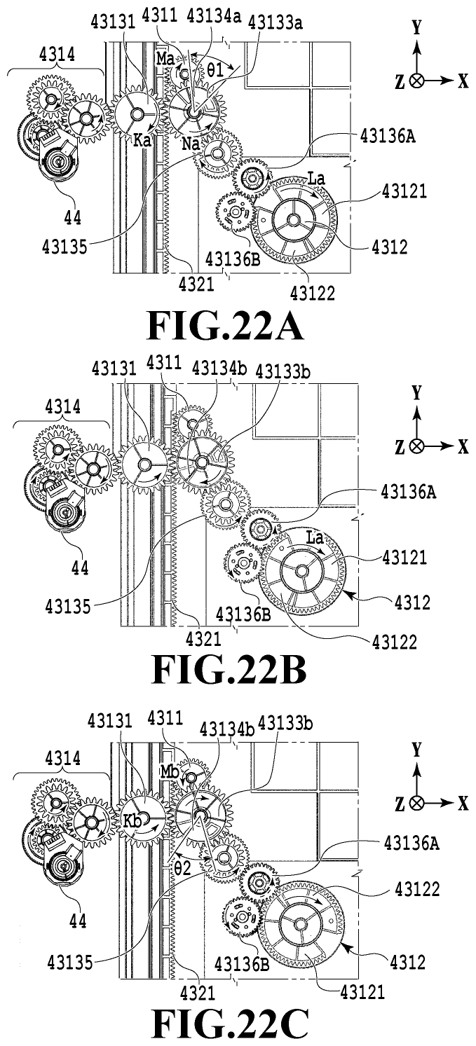

Next, a description is given about the transmission of the driving force to the pinion 4311. FIG. 22A to FIG. 22C are diagrams illustrating the transmission of the driving force using the drive train 431. FIG. 22A is a diagram illustrating the positional relationship between the convex part 43133a and the rib 43134a of the delay gear 43132 at the time the first output gear 43138A finishes meshing with the teeth 43121b of the first sector gear 43121. FIG. 22B is a diagram illustrating a state during the transition from FIG. 22A to FIG. 22C. FIG. 22C is a diagram is illustrating the positional relationship between the convex part 43133a and the rib 43134b of the delay gear 43132 at the time the first output gear 43138B finishes meshing with the teeth 43122b of the second sector gear 43122.

At the time the drive source 44 is driven to rotate in a predetermined direction to move the reciprocating member 433 in the −X direction, the first tray gear 43131 rotates in the direction of arrow Ka, causing the cam 4312 to rotate in the direction of arrow La. At this time, the first delay gear 43133 meshing with the first tray gear 43131 rotates in the direction of arrow Na. This rotation of the first delay gear 43133 causes the convex part 43133a to move toward the rib 43134a of the second delay gear 43134.

Further, at the time the first output gear 43138A of the one-way clutch 43136A finishes meshing with the teeth 43121b of the first sector gear 43121, the convex part 43133a and the rib 43134a are separated from each other. At this time, the angle formed by the abutment surface of the convex part 43133a to abut on the rib 43134a and the abutment surface of the rib 43134a to abut on the convex part 43133a is the angle θ1 (see FIG. 22A). In the present embodiment, the angle θ1 is an acute angle.

In this way, in the present embodiment, during the time the reciprocating member 433 is moving in the −X direction and at the completion of that movement, the convex part 43133a does not abut on the ribs 43134a and 43134b. That is, the driving force is not transmitted from the first delay gear 43133 to the second delay gear 43134, and the driving force is not transmitted to the rack part 4321 via the pinion 4311. Note that “during the time of moving in the −X direction and at the completion of that movement” mentioned above refers to “during the time of moving in the −X direction and at the time the cam part 4312b is made to stop at the top dead center by that movement.” Therefore, during the time the reciprocating member 433 is moving in the −X direction and at the completion of that movement, the expansion operation of the stacking part 4, i.e., the movement of the second stacking part 42 in the +Y direction, is not performed.

By driving the drive source 44 to rotate in a predetermined direction from the state illustrated in FIG. 22A so that the first tray gear 43131 is rotated in the direction of arrow Ka, the convex part 43133a and the rib 43134a are made to abut on each other. At this time, the first sector gear 43121 of the gear part 4312a is not meshed with the first output gear 43138A. Further, the first input gear 43137B rotates idly with respect to the first output gear 43138B meshing with the second sector gear 43122. Therefore, even if the first tray gear 43131 is further rotated in the direction of arrow Ka from the state illustrated in FIG. 22A, the cam 4312 does not rotate. Then, as the first tray gear 43131 further rotates in the direction of arrow Ka, the second delay gear 43134 rotates integrally with the first delay gear 43133. Accordingly, the driving force is transmitted to the pinion 4311 meshing with the second delay gear 43134, so that the pinion 4311 rotates in the direction of arrow Ma. Then, the rotation of the pinion 4311 in the direction of arrow Ma imparts the force to the rack part 4321 to move in the +Y direction, and accordingly, the second support member 432 moves in the +Y direction, and the second stacking part 42 supported by the second support member 432 moves in the +Y direction. The subsequent operations, including the operation of further rotating the first tray gear 43131 in the direction of arrow Ka from the state of FIG. 22A, are executed, for example, in the process of S1204 of the print processing. Further, the period from the rotation of the first tray gear 43131 further from the state illustrated in FIG. 22A until the second stacking part 42 starts moving in the +Y direction corresponds to the delay section described with reference to FIG. 11.

Next, the rotation direction of the drive source 44 is reversed, so as to rotate the cam 4312 in the direction of arrow La via each gear of the drive train 431 (see FIG. 22B). This rotation of the cam 4312 causes the reciprocating member 433 to move in the +X direction. At this time, the rotation direction of each gear in the drive train 431 is reversed, but the two one-way clutches 43136, the first sector gear 43121, and the second sector gear 43122 impart the force to the cam 4312 to rotate in the direction of arrow La, which is the same as before the drive source 44 was reversed. Further, at this time, since the convex part 43133a does not abut on the ribs 43134a and 43134b, the driving force transmitted to the first delay gear 43133 is not transmitted to the second delay gear 43134, the pinion 4311, or the rack part 4321.

Thereafter, even after the first output gear 43138B of the one-way clutch 43136B finishes meshing with the teeth 43122b of the second sector gear 43122, the convex part 43133a of the first delay gear 43133 and the rib 43134b of the second delay gear 43134 are separated from each other. At this time, the angle formed by the abutment surface of the convex part 43133a to abut on the rib 43134b and the abutment surface of the rib 43134b to abut on the convex part 43133a is the angle θ2 (see FIG. 22C). In the present embodiment, the angle θ2 is an acute angle.

In this way, in the present embodiment, during the time the reciprocating member 433 is moving in the +X direction and at the completion of that movement, the convex part 43133a does not abut on the ribs 43134a and 43134b. That is, the driving force is not transmitted from the first delay gear 43133 to the second delay gear 43134, and the driving force is not transmitted to the rack part 4321 via the pinion 4311. Note that “during the time of moving in the +X direction and at the completion of that movement” mentioned above refers to “during the time of moving in the +X direction and at the time the cam part 4312b is made to stop at the top dead center by that movement.” Therefore, during the time the reciprocating member 433 is moving in the +X direction and at the completion of that movement, the contraction operation of the stacking part 4, i.e., the movement of the second stacking part 42 in the −Y direction, is not performed.

By driving the drive source 44 from the state illustrated in FIG. 22C so that the first tray gear 43131 is rotated in the direction of arrow Kb, the convex part 43133a and the rib 43134b are made to abut on each other. At this time, the second sector gear 43122 of the gear part 4312a is not meshed with the first output gear 43138B. Further, the first input gear 43137A rotates idly with respect to the first output gear 43138A meshing with the first sector gear 43121. Therefore, even if the first tray gear 43131 is further rotated in the direction of arrow Kb from the state illustrated in FIG. 22C, the cam 4312 does not rotate. Then, as the first tray gear 43131 further rotates in the direction of arrow Kb, the second delay gear 43134 rotates integrally with the first delay gear 43133. Accordingly, the pinion 4311 meshing with the second delay gear 43134 rotates in the direction of arrow Mb. Then, the rotation of the pinion 4311 in the direction of arrow Mb imparts the force to the rack part 4321 to move in the −Y direction, and accordingly, the second support member 432 moves in the −Y direction, and the second stacking part 42 supported by the second support member 432 moves in the −Y direction. The subsequent operations, including the operation of further rotating the first tray gear 43131 in the direction of arrow Kb from the state of FIG. 22C, are executed, for example, in the process of S1246 of the print processing. Further, the period from the rotation of the first tray gear 43131 further from the state illustrated in FIG. 22C until the second stacking part 42 starts moving in the −Y direction corresponds to the delay section described with reference to FIG. 11.

In this way, in the present embodiment, the drive train 431 functions as a transmission part that transmits the driving force from the drive source 44 to the reciprocating member 433 that moves the stacking part 4 and to the second support member 432 that expands and contracts the stacking part 4.

### (Functional Effect)

As described above, in the present embodiment, the timing at which the driving force is transmitted to move the stacking part in the X direction is different from the timing at which the driving force is transmitted to expand and contract the stacking part in the Y direction. Specifically, in the drive train, a delay gear is used to transmit the driving force so that the movement of the second stacking part in the Y direction occurs a predetermined period after the movement of the first stacking part in the width direction. This allows the stacking part to be moved in the X direction and then expanded and contracted in the Y direction by a drive train configured with multiple gears, making it possible to control the movement of the stacking part in both X direction and Y direction using a single drive source.

Further, in the present embodiment, the stacking part is moved in the X direction and expanded and contracted in the Y direction by one driving source, using the delay gear, the two one-way clutches, and the two sector gears. Accordingly, it is possible to downsize the printing part 10, which contributes to downsizing the printing apparatus 1.

### Other Embodiments

Note that the above-described embodiments may be modified as shown in the following (1) through (10).
(1) Although not specifically described in the above embodiments, in the printing apparatus 1, the print processing that performs printing on print media and sorts the print media after printing (see FIG. 12) and the print processing that does not execute the sorting can be selected based on an input from the operation part 8 or the like. In a case of the print processing that does not execute the sorting, for example, after moving to the first sorting position, the print media after printing continue to be discharged in the state where the second stacking part 42 has been moved to the stack position. Further, in the case of the print processing that does not execute the sorting, for example, if it is determined in S1218 that the part number n has not reached the predetermined part number, the processing proceeds to S1240. Furthermore, in the case of the print processing that does not execute the sorting, for example, S1202 and S1222 may be omitted.

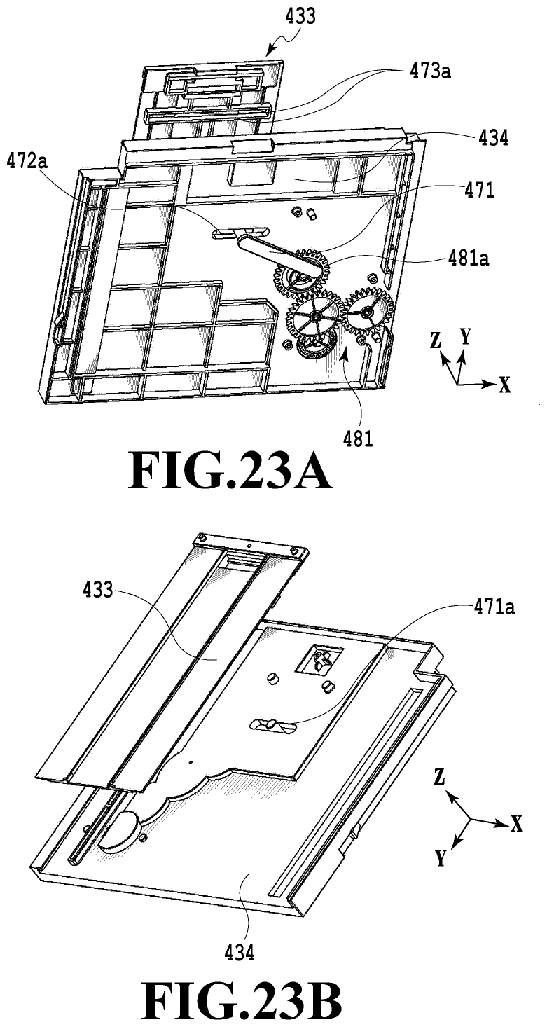

Note that in the above-described embodiments, the case in which the instruction “Sort into N parts for every M sheets” is input by a job or the operation part 8 is described, using the flowchart of FIG. 12. However, in actual printing operations, even in a case where M and N are known, there may be a designation not to perform sorting. For such cases, a configuration for switching whether or not to transmit the driving force of the drive source 44 to the engagement part 4333 is installed in advance, and in a case where sorting is not performed, the stacking part 4 may be controlled not to move between the first sorting position and the second sorting position.
(2) In the above-described embodiments, the drive transmission part 43 is formed such that, in a state where the first stacking part 41 is positioned at the first sorting position, the cam 4312 does not rotate any further even if the driving force resulting from the rotation of the drive source 44 in the first direction is transmitted. However, the drive transmission part 43 is not limited to this configuration. For example, the drive transmission part 43 may be formed such that, in a state where the first stacking part 41 is positioned at a predetermined position on one side in the X direction relative to the first sorting position, the cam 4312 does not rotate any further even if the driving force resulting from the rotation of the drive source 44 in the first direction is transmitted. In this case, in the print processing of FIG. 12, after moving the first stacking part 41 to the predetermined position, the drive source 44 is further rotated in the first direction to move the second stacking part 42 from the accommodated position to the stack position. Then, the drive source 44 is rotated in the second direction, thereby moving the first stacking part 41 in the +X direction to the first sorting position. At this time, the position of the first stacking part 41 is determined based on a detection result of a sensor installed in the detection part 73 to detect the position of the stacking part 4 after a predetermined operation.
(3) In the above-described embodiments, the drive transmission part 43 is formed such that, in a state where the first stacking part 41 is at the second sorting position, the cam 4312 does not rotate any further even if the driving force resulting from the rotation of the drive source 44 in the second direction is transmitted. However, the drive transmission part 43 is not limited to this configuration. For example, the drive transmission part 43 may be formed such that, in a state where the first stacking part 41 is at a predetermined position on the other side in the X direction relative to the second sorting position, the cam 4312 does not rotate any further even if the driving force resulting from the rotation of the drive source 44 in the second direction is transmitted.
(4) In the above-described embodiments, in the accommodated position, a partial area on the end portion 42a side of the second stacking part 42 protrudes forward in the Y direction from the housing 9 (see FIG. 6A); however, there is no such limitation. It is also possible that the second stacking part 42 is configured not to protrude forward from the housing 9 in the accommodated position. That is, in this case, the second stacking part 42 is completely accommodated within the housing 9 in the accommodated position. Further, in the above-described embodiments, the stacking part 4 sorts the ejected print media by stacking them at two locations, i.e., the first sorting position and the second sorting position; however, the positions for sorting are not limited to the two locations. For example, it is also possible to sort discharged print media at three or more different locations in the X direction.
(5) In the above-described embodiments, the printing apparatus 1 may be what is termed as a serial-scan type printing apparatus that performs printing by ejecting ink, while moving the print head 3 in the X direction, onto a print medium being conveyed; however, there is no such limitation. The printing apparatus applicable to the present disclosure may also be other type, such as, for example what is termed as a line-type printing apparatus that performs printing on a print medium conveyed in the Y direction using a print head capable of ejecting ink within a range corresponding to a printable size of print medium with respect to the X direction.
(6) In the above-described embodiments, the first sorting position is set such that the center position Os of the stacking part 4 in the X direction is located on one side in the X direction relative to the center position Om of the print media to be discharged, and the second sorting position is set such that the center position Os is located on the other side in the X direction relative to the center position Om. However, the first sorting position and the second sorting position are not limited to this. For example, either the first sorting position or the second sorting position may be set such that the center position Os coincides with the center position Om. Further, in the above-described embodiments, the initial position during the non-printing time in which printing is not performed is set to the position where the center position Os of the stacking part 4 coincides with the center position Om of the print media to be discharged; however, there is no such limitation. The initial position may be set to the first sorting position, the second sorting position, or a predetermined position other than the first sorting position and the second sorting position.
(7) In the above-described embodiments, the case where the instruction “Sort into N parts for every M sheets” is set in the job is described. However, the job may also be in a form where a command to change the sorting position is interposed between the image data of a predetermined page and the image data of the next page. In this case, the control part 71 may sequentially execute operations in accordance with the received command, such as printing and discharging according to the image data of the predetermined page, changing the sorting position, and printing and discharging according to the image data of the next page.
(8) In the above-described embodiments, as the configuration for moving the stacking part 4 in the X direction, the reciprocating member 433 is configured to be moved in the X direction using the cam 4312; however, there is no such limitation. As the configuration for moving the stacking part 4 in the X direction, for example, the reciprocating member 433 may be moved in the X direction using a link, as illustrated in FIG. 23A and FIG. 23B. FIGS. 23A and 23B are diagrams illustrating a modification example of the mechanism for moving the stacking part 4 in the X direction using a link.

Specifically, the link 471 and the gear train 481 for transmitting a driving force to the link 471 are supported by the first support member 434. The sliding part 471a formed on the link 471 penetrates through the guide hole 472a formed in the first support member 434 and is fitted into the sliding surfaces 473a formed on the reciprocating member 433. Due to the rotation of the gear 821a fixed to the link 471, the link 471 performs translational and rotational motion, causing the reciprocating member 433 to reciprocate in the X direction via the sliding part 471a and the sliding surfaces 473a.
(9) Although not specifically mentioned in the above-described embodiments, the technology according to the present disclosure is not limited to being applied to a printing apparatus. For example, applications to various devices such as a stacking device or a conveyance device that includes a stacking part for stacking sheets that are conveyed and discharged after a predetermined process is performed thereon.
(10) The above-described embodiments and various forms shown in (1) through (9) may be combined as appropriate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it becomes possible to downsize an apparatus.

This application claims the benefit of Japanese Patent Application No. 2024-124844, filed Jul. 31, 2024, which is hereby incorporated by reference herein in its entirety.

What is claimed is:

1. A stacking device comprising:
a stacking unit configured to expand or contract in a conveyance direction of a print medium to be conveyed and discharged, and configured to be movable in a width direction of the print medium, which intersects with the conveyance direction, and to be capable of stacking the print medium to be discharged; and
a transmission unit configured to transmit a driving force from a drive source to the stacking unit,
wherein the transmission unit transmits the driving force such that a timing at which the stacking unit expands or contracts in the conveyance direction differs from a timing at which the stacking unit moves in the width direction.

2. The stacking device according to claim 1,
wherein the transmission unit transmits the driving force such that the stacking unit expands or contracts in the conveyance direction after the stacking unit moves in the width direction.

3. The stacking device according to claim 1,
wherein the stacking unit includes
a first stacking part configured to be movable in the width direction, and
a second stacking part configured to be movable in the conveyance direction relative to the first stacking part, and
wherein the transmission unit transmits the driving force such that the stacking unit expands or contracts in accordance with movement of the second stacking part in the conveyance direction.

4. The stacking device according to claim 3,
wherein the transmission unit includes
a first transmission path configured to transmit the driving force for causing the first stacking part to move in the width direction,
a second transmission path configured to transmit the driving force for causing the second stacking part to move in the conveyance direction, and
a delay gear configured to transmit the driving force to the second transmission path such that movement of the second stacking part in the conveyance direction is performed a predetermined period after movement of the first stacking part in the width direction.

5. The stacking device according to claim 4,
wherein the delay gear includes
a first gear configured with two ribs and configured to transmit the driving force to the second transmission path, and
a second gear that configured with a convex part formed on a surface facing the first gear and configured to transmit the driving force to the first transmission path, and
wherein the first gear rotates integrally with the second gear in a state where the convex part of the second gear is abutting on either one of the two ribs.

6. The stacking device according to claim 5,
wherein, in a case where the drive source rotates in a first direction, the convex part of the second gear abuts on one of the two ribs, so that the second stacking part is moved via the second transmission path in a direction of expanding the stacking unit, and
wherein, in a case where the drive source rotates in a second direction opposite to the first direction, the convex part of the second gear abuts on the other one of the two ribs, so that the second stacking part is moved via the second transmission path in a direction of contracting the stacking unit.

7. The stacking device according to claim 6,
wherein the first transmission path includes
a first one-way clutch located upstream in a transmission direction of the driving force, and configured to transmit the driving force in a case where the drive source rotates in the first direction,
a second one-way clutch located downstream in the transmission direction, and configured to transmit the driving force in a case where the drive source rotates in the second direction opposite to the first direction, and
a cam configured to rotate using the first one-way clutch and second one-way clutch to move the first stacking part in the width direction,
wherein the cam includes a gear part which is equipped with a first sector gear configured to mesh with the first one-way clutch and a second sector gear configured to mesh with the second one-way clutch, and
wherein areas where teeth are formed in the first sector gear and the second sector gear partially overlap with each other in a circumferential direction of the gear part.

8. The stacking device according to claim 7,
wherein, in a case where the drive source rotates in the first direction, the cam rotates using the first sector gear, such that the stacking unit moves toward one side from the other side in the width direction, and
wherein, in a case where the drive source rotates in the second direction, the cam rotates using the second sector gear, such that the stacking unit moves toward the other side from the one side in the width direction.

9. The stacking device according to claim 7,
wherein the cam includes a cam part arranged eccentrically with respect to a rotation center, and
wherein the first stacking part engages with the cam part and moves in the width direction via the cam part.

10. The stacking device according to claim 8,
wherein, in a state where the first one-way clutch finishes meshing with the first sector gear, the convex part and the either one of the ribs do not abut on each other, and
wherein, in a state where the second one-way clutch finishes meshing with the second sector gear, the convex part and the other one of the ribs do not abut on each other.

11. The stacking device according to claim 4,
wherein the first stacking part moves in the width direction via a link configured to perform translational and rotational motion using the driving force transmitted through the second transmission path.

12. The stacking device according to claim 7,
wherein the first one-way clutch and the second one-way clutch include
an input gear configured with an idling part that allows a received planetary gear to idle and a locking part that locks the planetary gear, and
an output gear configured with internal teeth with which the planetary gear received by the input gear meshes, and configured to mesh with a sector gear of the cam, and
wherein the output gear rotates integrally with the input gear in a state where the planetary gear is locked by the locking part.

13. The stacking device according to claim 1 further comprising:
a printing unit configured to perform printing on the print medium;
a conveyance unit configured to convey the print medium to a position where printing is performed by the printing unit and to discharge the print medium after printing; and
a control unit configured to control driving of the drive source in accordance with discharge of the print medium performed by the conveyance unit.
